(19) United States
(12) Patent Application Publication
(10) Pub. No.: US 2026/0257453 A1
(43) Pub. Date: Sep. 3, 2026

(54) VEHICLE INTERIOR COMPONENT

(71) Applicant: Yanfeng International Automotive Technology Co. Ltd., Novi, MI (US)

(72) Inventors: Jie SHI, Shanghai (CN); Liyong WANG, Shanghai (CN); Jie SUN, Shanghai (CN)

(21) Appl. No.: 19/658,662

(22) Filed: Apr. 26, 2026

Related U.S. Application Data
(63) Continuation-in-part of application No. PCT/CN2024/127326, filed on Oct. 25, 2024.

(30) Foreign Application Priority Data
Oct. 26, 2023 (CN) 202311406760.8

(51) Int. Cl. B32B 5/24; B32B 5/02; B32B 5/18; B32B 25/04; B32B 25/16; B60R 13/02

(52) U.S. Cl. CPC B32B 5/245; B32B 5/022; B32B 5/028; B32B 5/18; B32B 25/045; B32B 25/16; B32B 2262/0284; B32B 2262/065; B32B 2605/003; B60R 13/02

(57) ABSTRACT

A component for a vehicle interior comprising a composite structure is disclosed. The composite structure may comprise a substrate/base and cover comprising base layer and cover layer configured to provide a surface effect such as visual effect and/or performance effect. The cover layer may comprise an applied material, formed/molded material, coating, treatment, laminate, film, etc.; the base layer may comprise a formed/molded material, polymer material, thermoplastic elastomer, foam/soft material, etc. The composite structure may comprise a multi-layer structure comprising a polymer/PET material, fabric layer, non-woven layer, formed/molded materials, soft/cushion layer, barrier/intermediate layer in/at the cover, coating/treatment layer, etc. The substrate may comprise a structure, formed/molded structure, panel, formed/molded panel, fiber panel, foam/resilient panel, composite panel, etc. The surface effect may comprise durability/wear resistance, scratch resistance, stain resistance, liquid repellence, anti-fouling, touch-feel/tactile performance, hardness/softness, friction coefficient, adhesion, decorative/color effect, etc. A method of making the composite structure is disclosed.

### CROSS-REFERENCE TO RELATED APPLICATIONS

The present application is a continuation-in-part of PCT/International Patent Application No. PCT/CN2024/127326 titled “MULTI-LAYER MATERIAL AND MANUFACTURING METHOD THEREFOR” filed Oct. 25, 2024, that claims the benefit of Chinese Patent Application No. 202311406760.8 titled “A MULTILAYER MATERIAL AND A METHOD FOR PREPARING THE SAME” filed Oct. 26, 2023.

The present application claims priority to and incorporates by reference in full the following applications: (1) PCT/International Patent Application No. PCT/CN2024/127326 titled “MULTI-LAYER MATERIAL AND MANUFACTURING METHOD THEREFOR” filed Oct. 25, 2024; and (2) Chinese Patent Application No. 202311406760.8 titled “A MULTILAYER MATERIAL AND A METHOD FOR PREPARING THE SAME” filed Oct. 26, 2023.

The present application relates to the following patent applications/documents: (1) PCT/International Patent Application No. PCT/CN2024/128481 titled “SKIN MATERIAL FOR VEHICLE AND VEHICLE TRIM COMPRISING SKIN MATERIAL” filed Oct. 30, 2024; and (2) Chinese Patent Application No. 202311443381.6 titled “SKIN MATERIAL FOR VEHICLE AND VEHICLE TRIM COMPRISING SKIN MATERIAL” filed Nov. 1, 2023; (3) U.S. patent application Ser. No. 19/665,640 titled “COMPONENT FOR VEHICLE INTERIOR” filed May 1, 2026; (4) PCT/International Patent Application No. PCT/CN2024/127326 titled “MULTI-LAYER MATERIAL AND MANUFACTURING METHOD THEREFOR” filed Oct. 25, 2024; and (5) Chinese Patent Application No. 202311406760.8 titled “A MULTILAYER MATERIAL AND A METHOD FOR PREPARING THE SAME” filed Oct. 26, 2023.

### FIELD

The present invention relates to a composite structure for a component for a vehicle interior.

The present invention also relates to a composite structure for a component for a vehicle interior comprising a substrate/base and a cover comprising a cover layer and a base layer.

### BACKGROUND

It is known to provide a composite structure for a component for a vehicle interior comprising a substrate/base and a cover.

It would be advantageous to provide an improved composite structure for a component for a vehicle interior comprising a substrate/base and cover comprising a base layer and a cover layer configured to provide a surface effect such as a visual effect and/or a performance effect.

### SUMMARY

The present invention relates to a component comprising a composite structure comprising a cover and a structural substrate; the cover may comprise a base layer and a cover layer; the base layer of the cover may be configured to provide a base for the cover; the cover layer of the cover may be configured to provide an exterior surface for the composite structure; the cover layer of the cover may comprise a cover layer material on the base layer of the cover; the cover layer material may comprise an applied material and/or a formed material; the base layer of the cover may comprise a base layer material. The composite structure may comprise an interface between the structural substrate and the cover the interface may comprise an intermediate layer; the cover layer material may comprise an applied material comprising a coating; the cover layer may comprise a molded layer and/or an injection molded layer and/or a foam molded layer and/or a cover layer; the base layer may comprise a molded layer; the base layer material may comprise a polymer material and/or a molded material and/or an injection-molded material and/or a film and/or a polymer material and/or an elastomer and/or a thermoplastic elastomer and/or at least one of TPEE and/or TPU and/or TPV and/or TPE-S; the cover layer may comprise a molded layer; the cover layer may comprise a polymer material and/or a molded material and/or an injection-molded material and/or a film and/or a polyurethane material and/or an acrylic material comprising silicone and/or a polymer material comprising fluorine and/or a stain-resistant polymer material; the structural substrate may comprise a panel and/or a base and/or a fiber panel and/or a compressed fiber panel and/or a reduced-density material and/or a stiffness-retaining material and/or a molded substrate; the intermediate layer may comprise a resilient material and/or a compressible material and/or a cushioning material and/or a foam material and/or a foam-based material and/or a film; the cover may be configured to provide a surface effect comprising a visual effect and/or a performance effect; the performance effect may comprise stain resistance and/or fluid repellence and/or hardness and/or scratch resistance and/or tactile performance; the structural substrate may comprise hemp fiberboard and/or foamed hemp fiberboard and/or foamed glass fiberboard and/or polypropylene and/or polyimide and/or polycarbonate; the base layer may comprise a polyethylene terephthalate fiber material and/or a nonwoven fabric material and/or a mesh fabric and/or foam material and/or sponge material and/or thermoplastic polyester elastomer and/or a foamed material and/or polyethylene terephthalate fiber nonwoven fabric; the cover layer may comprise thermoplastic polyester elastomer and/or thermoplastic vulcanized rubber and/or polyurethane and/or a self-skinned material formed from thermoplastic polyester elastomer; the barrier layer may comprise polypropylene and/or polyethylene and/or polyethylene terephthalate and/or thermoplastic polyurethane elastomer and/or thermoplastic polyester elastomer the barrier layer may comprise a material configured to limit penetration of material of the cover layer into material of the base layer during formation of the cover; the barrier layer may comprise a material having compatibility with material of the cover layer; and the barrier layer may comprise a laminate with the base layer; the interface layer may comprise polypropylene and/or polyethylene and/or polyethylene terephthalate and/or thermoplastic polyurethane elastomer and/or thermoplastic polyester elastomer; the interface layer may comprise a laminate with the structural substrate; the cover layer material may comprise antifouling coating characteristics; the surface effect may comprise adhesion evaluation and/or wear resistance and/or stain resistance evaluation and/or water droplet angle and/or feel evaluation and/or static and/or dynamic friction coefficient; the component may be produced by a method comprising the steps of: providing the base layer material for the cover, providing the cover layer material for the cover on the base layer of the cover, and providing the cover on the structural substrate; the step of providing the cover layer material for the cover on the base layer of the cover may comprise forming the cover layer material on the base layer; the step of providing the base layer material for the cover may comprise forming the base layer from the base layer material on the structural substrate; the method may further comprise the step of forming a barrier layer between the base layer and the cover layer to form a layer structure.

The present invention relates to a component comprising a composite structure comprising a cover and a structural substrate; the cover may comprise a base layer and a cover layer; the base layer of the cover may be configured to provide a base for the cover; the cover layer of the cover may be configured to provide an exterior surface for the composite structure; the cover layer of the cover may comprise a cover layer material on the base layer of the cover; the cover layer material may comprise an applied material and/or a formed material; the base layer of the cover may comprise a base layer material; the composite structure may comprise an interface between the structural substrate and the cover. The interface may comprise an interface layer; the interface may comprise a barrier layer; the interface may comprise an intermediate layer; the cover may comprise the interface; the cover may comprise the intermediate layer; the intermediate layer of the cover may be provided between the structural substrate and the cover layer; the cover may comprise a barrier layer; the cover may comprise a coating; the cover may comprise a polymer material; the cover layer material of the cover layer may comprise a formed material; the cover layer material of the cover layer may comprise a molded material; the cover layer material may comprise an applied material; the applied material may comprise a coating; the cover layer may comprise a coating; the coating may comprise an applied coating; the applied coating may comprise a coating at the exterior surface; the cover may comprise a skin; the skin may comprise the cover layer; the cover layer may comprise a molded layer; the cover layer may comprise an injection molded layer; the cover layer may comprise a foam molded layer; the cover layer may comprise a cover layer; the cover layer may comprise a self-skinned layer; the cover layer material may comprise a self-skinned material; the base layer may comprise a resin; the base layer material may comprise a resin; the base layer may comprise a molded layer; the base layer may comprise an injection-molded layer; the base layer may comprise a polymer material; the base layer material may comprise a polymer material; the base layer material may comprise a molded material; the base layer material may comprise an injection-molded material; the base layer material may comprise a film; the base layer material may comprise a polymer material; the base layer material may comprise an elastomer; the base layer material may comprise a thermoplastic elastomer; the base layer material may comprise at least one of TPEE, TPU, TPV and or TPE-S.

The present invention relates to a component comprising a composite structure comprising a cover and a structural substrate; the cover may comprise a base layer and a cover layer; the base layer of the cover may be configured to provide a base for the cover; the cover layer of the cover may be configured to provide an exterior surface for the composite structure; the cover layer of the cover may comprise a cover layer material on the base layer of the cover; the cover layer material may comprise an applied material and/or a formed material; the base layer of the cover may comprise a base layer material; the composite structure may comprise an interface between the structural substrate and the cover. The cover layer may comprise a resin; the cover layer material may comprise a resin; the cover layer may comprise a molded layer; the cover layer may comprise an injection-molded layer; the cover layer may comprise a polymer material; the cover layer material may comprise a polymer material; the cover layer material may comprise a molded material; the cover layer material may comprise an injection-molded material; the cover layer material may comprise a polymer material; the cover layer material may comprise a film; the cover layer material may comprise a polyurethane material; the cover layer material may comprise an acrylic material; the cover layer may comprise an acrylic substrate; the cover layer material may comprise a polymer material comprising silicone; the cover layer material may comprise a polymer material comprising fluorine; the cover layer material may comprise a stain-resistant polymer material; the structural substrate may comprise a panel; the structural substrate may comprise a base; the structural substrate may comprise a fiber panel; the structural substrate may comprise a compressed fiber panel; the structural substrate may comprise a reduced-density material; the structural substrate may comprise a stiffness-retaining material; the structural substrate may comprise a molded substrate; the intermediate layer may comprise a resilient material; the intermediate layer may comprise a compressible material; the intermediate layer may comprise a cushioning material; the intermediate layer may comprise a foam material; the intermediate layer may comprise a foam-based material; the intermediate layer may comprise a film; the cover layer may comprise a polymer material; the intermediate layer may comprise a polymer material; the barrier layer may comprise a polymer material; the interface layer may comprise a polymer material; the cover layer may comprise a resistant layer; the cover layer may comprise a stain-resistant layer; the cover layer may comprise a resistant coating; the cover layer may comprise an anti-fouling coating; the cover layer may comprise a polyurethane material; the cover layer material may comprise a textured material; the external surface of the cover layer may comprise a textured surface; the external surface of the cover layer may comprise a patterned surface; the cover may be configured to provide a surface effect; the cover may be configured to provide a surface effect at the exterior surface; the surface effect may comprise a visual effect; the visual effect may comprise a decorative effect; the surface effect may comprise a performance effect; the performance effect may comprise stain resistance; the performance effect may comprise fluid repellence; the performance effect may comprise hardness; the performance effect may comprise scratch resistance; the performance effect may comprise tactile performance; tactile performance may comprise touch feel; the cover may be configured to provide a performance effect at the exterior surface; the performance effect may comprise tactile performance.

The present invention relates to a component comprising a composite structure comprising a cover and a structural substrate; the cover may comprise a base layer and a cover layer; the base layer of the cover may be configured to provide a base for the cover; the cover layer of the cover may be configured to provide an exterior surface for the composite structure; the cover layer of the cover may comprise a cover layer material on the base layer of the cover; the cover layer material may comprise an applied material and/or a formed material; the base layer of the cover may comprise a base layer material; the composite structure may comprise an interface between the structural substrate and the cover. The structural substrate may comprise hemp fiberboard and/or foamed hemp fiberboard and/or foamed glass fiberboard and/or polypropylene and/or polyimide and/or polycarbonate; the structural substrate may comprise hemp fiberboard; the composite structure may comprise polyethylene terephthalate fiber nonwoven fabric and/or three-dimensional mesh fabric and/or foam and/or sponge and/or thermoplastic polyester elastomer and/or a foamed material; the cover may comprise polyethylene terephthalate fiber nonwoven fabric and/or three-dimensional mesh fabric and/or foam and/or sponge and/or thermoplastic polyester elastomer and/or a foamed material; the base layer may comprise a polyethylene terephthalate fiber material and/or a nonwoven fabric material and/or a mesh fabric and/or foam material and/or sponge material and/or thermoplastic polyester elastomer and/or a foamed material and/or polyethylene terephthalate fiber nonwoven fabric; the base layer may comprise polyethylene terephthalate fiber nonwoven fabric; the base layer may comprise three-dimensional mesh fabric; the base layer may comprise a foam layer; the base layer may comprise thermoplastic polyester elastomer; the base layer may comprise a foamed material formed from thermoplastic polyester elastomer; the cover layer may comprise thermoplastic polyester elastomer and/or thermoplastic vulcanized rubber and/or polyurethane; the cover layer may comprise thermoplastic polyester elastomer; the cover layer may comprise a self-skinned material formed from thermoplastic polyester elastomer; the barrier layer may comprise polypropylene and/or polyethylene and/or polyethylene terephthalate and/or thermoplastic polyurethane elastomer and/or thermoplastic polyester elastomer; the barrier layer may comprise thermoplastic polyurethane elastomer; the barrier layer may comprise thermoplastic polyester elastomer; the interface layer may comprise polypropylene and/or polyethylene and/or polyethylene terephthalate and/or thermoplastic polyurethane elastomer and/or thermoplastic polyester elastomer; the interface layer may comprise polyethylene; the barrier layer may comprise a material configured to limit penetration of material of the cover layer into material of the base layer during formation of the cover; the barrier layer may comprise a material having compatibility with material of the cover layer; the barrier layer may comprise a laminate with the base layer; the interface layer may comprise a laminate with the structural substrate; the structural substrate may comprise a thickness of 1.5 mm to 3 mm; the structural substrate may comprise a flexural modulus of at least 1800 MPa; the structural substrate may comprise a density of less than 0.85 g/\hat{ }3; the base layer may comprise a thickness of 0.5 mm to 3 mm; the base layer may comprise a Shore C hardness of 30 to 60; the cover layer may comprise a thickness of 0.4 mm to 1.2 mm; the cover layer may comprise a Shore A hardness of 40 to 80; the cover layer may comprise a density of 1.0 g/cm\hat{ }3 to 1.3 g/cm\hat{ }3; the cover layer material may comprise a coating film-forming resin and/or water-based acrylic resin and/or water-based polyurethane resin and/or coating auxiliary components and/or fluorine-containing polymers and/or silane-containing polymers, etc.; the cover layer material may comprise isocyanate and/or carbide diamine and/or a leveling agent and/or defoamer and/or color paste and/or antioxidant and/or UV resistant additive, etc.; the cover layer material may comprise may comprise antifouling coating characteristics and/or cross-linking density of the film-forming resin and/or acrylic resin and/or fluorine-containing polymers and/or silicon-containing polymer material, dry film thickness of coating: 3~30 μm, preferably 8~15 μm; the base layer material may comprise a thermoplastic resin and/or TPEE polyester elastomer and/or TPU polyurethane elastomer and/or TPV thermoplastic vulcanized elastomer and/or TPE-S thermoplastic styrene elastomer, etc.; the cover may be may be formed by thermoplastic forming and/or in-mold injection molding and/or in-mold foam injection molding and/or extrusion and calendering and/or slush process molding, etc.; the surface effect may comprise adhesion evaluation and/or wear resistance and/or stain resistance evaluation and/or water droplet angle and/or feel evaluation and/or static and dynamic friction coefficient, etc.

The present invention relates to a component comprising a composite structure comprising a cover and a structural substrate; the cover may comprise a base layer and a cover layer; the base layer of the cover may be configured to provide a base for the cover; the cover layer of the cover may be configured to provide an exterior surface for the composite structure; the cover layer of the cover may comprise a cover layer material on the base layer of the cover; the cover layer material may comprise an applied material and/or a formed material; the base layer of the cover may comprise a base layer material; the composite structure may comprise an interface between the structural substrate and the cover. The component may be produced by a method comprising the steps of providing the base layer material for the cover and providing the cover layer material for the cover on the base layer of the cover; the method may further comprise the step of forming the structural substrate; the method may further comprise the step of providing the cover on the structural substrate; the step of providing the cover layer material for the cover on the base layer of the cover may comprise applying the cover layer material on the base layer; the step of providing the cover layer material for the cover on the base layer of the cover may comprise applying the cover layer material as a coating on the base layer; the step of providing the cover layer material for the cover on the base layer of the cover may comprise forming the cover layer material on the base layer; the method may further comprise the step of providing a barrier layer on the base layer of the cover; the barrier layer may be under the cover layer of the cover and on the base layer of the cover; the method may further comprise the step of providing an intermediate layer under the base layer of the cover; the intermediate layer may be formed on the structural substrate; the step of providing the base layer material for the cover may comprise forming the base layer from the base layer material on the structural substrate; the step of providing the base layer material for the cover may comprise molding the base layer on the structural substrate; the step of providing the base layer material for the cover may comprise injection molding the base layer on the structural substrate; the step of providing the cover layer material for the cover may comprise forming the cover layer from the cover layer material to provide the exterior surface for the composite structure; the method may further comprise the step of forming the barrier layer between the base layer and the cover layer; the method may further comprise the step of combining the barrier layer with the base layer to form a layer structure; the method may further comprise the step of forming the cover layer on the base layer; the method may further comprise the steps of providing the barrier layer on the base layer and forming the cover layer on the barrier layer; the method may further comprise the step of laminating the barrier layer on the base layer; the method may further comprise the step of forming the cover layer by foam injection molding; the method may further comprise the step of forming the cover layer by molding a self-cover layer on the base layer of the cover; the method may further comprise the step of assembling the structural substrate of the composite structure.

The present invention relates to a composite structure for a component for vehicle interior comprising a structural substrate and a cover; the cover may comprise a base layer and a cover layer; the base layer may be provided between the structural substrate and the cover layer. The cover layer of the cover may be formed by injection molding and/or foam injection molding; a barrier layer may be provided between the base layer and the cover layer of the cover; the barrier layer may comprise a layer/membrane; the composite structure may comprise a multi-layer material; an intermediate layer may be provided between the structural substrate and the base layer of the cover; the intermediate layer may comprise a layer/membrane; the substrate of the composite structure may comprise a structural substrate and/or hemp fiberboard and/or foamed hemp fiberboard and/or foamed glass fiberboard and/or polypropylene and/or polyimide and/or polycarbonate, etc.; the base layer of the cover of the composite structure may comprise a cover/base layer and/or polyethylene terephthalate fiber nonwoven fabric and/or three-dimensional mesh fabric and/or sponge and/or thermoplastic polyester elastomer and/or intermediate foam layer formed by foaming thermoplastic polyester elastomer, etc.; the cover layer of the cover of the composite structure may comprise a cover layer and/or a thermoplastic polyester elastomer or a self-skinned surface formed therefrom after foaming and/or thermoplastic vulcanized rubber and/or polyurethane, etc.; the substrate may comprise a thickness of 1.5 mm-3 mm; the substrate may comprise a flexural modulus of over 1800 Mpa; the substrate may comprise a density of less than 0.85 g/cm\hat{ }3; the thickness of the base layer may be 0.5 mm-3 mm and/or the Shore hardness C may be 30-60 degrees; the cover layer may comprise a thickness of 0.4 mm-1.2 mm; the cover layer may comprise a Shore A hardness of 40-80; the cover layer may comprise a density of 1 g/cm cm\hat{ }3-1.3 g/cm cm\hat{ }3; the barrier layer may comprise a layer/membrane and/or the intermediate layer may comprise a layer/membrane; each layer/membrane may comprise polypropylene and/or polyethylene and/or polyethylene terephthalate and/or thermoplastic polyurethane elastomer and/or thermoplastic polyester elastomer, etc.; the cover may comprise a composite form comprising at least two layers; the substrate and the base layer may be provided in a composite form; the composite structure may comprise a structural substrate; the cover layer may comprise a skin; the base layer may comprise a cover/base layer; the cover/base layer may be between the structural substrate and the skin; the skin may comprise a cover layer formed by injection molding and/or foam injection molding; the barrier layer may comprise a layer/membrane between the cover/base layer and the cover layer; the composite structure may comprise a multi-layer material; the cover of the composite structure may comprise a multi-layer material; the substrate of the composite structure may comprise a structural substrate and/or hemp fiberboard and/or foamed hemp fiberboard and/or foamed glass fiberboard and/or polypropylene and/or polyimide and/or polycarbonate, etc.; the base layer of the cover of the composite structure may comprise a cover/base layer may comprise polyethylene terephthalate fiber nonwoven fabric and/or three-dimensional mesh fabric and/or sponge and/or thermoplastic polyester elastomer and/or intermediate foam layer formed by foaming thermoplastic polyester elastomer; the cover layer of the cover of the composite structure may comprise a cover layer and/or a thermoplastic polyester elastomer and/or a self-skinned surface formed therefrom after foaming and/or thermoplastic vulcanized rubber and/or polyurethane; the composite structure may comprise a multi-layer material; the structural substrate may comprise a thickness of 1.5 mm-3 mm; the structural substrate may comprise a flexural modulus of over 1800 Mpa; the structural substrate may comprise a density of less than 0;85 g/cm\hat{ }3; the thickness of the cover/base layer may be 0.5 mm-3 mm; the Shore hardness C of the cover/base layer may be 30-60 degrees; the cover layer may comprise a thickness of 0.4 mm-1.2 mm; the cover layer may comprise a Shore A hardness of 40-80; the cover layer may comprise a density of 1 g/cm\hat{ }3-1;3 g/cm cm\hat{ }3; the composite structure may comprise a multi-layer material; the barrier layer may comprise a first layer/membrane and the second layer/membrane; the first layer/membrane and the second layer/membrane may each independently comprise polypropylene and/or polyethylene and/or polyethylene terephthalate and/or thermoplastic polyurethane elastomer and/or thermoplastic polyester elastomer, etc.; the cover/base layer may comprise a composite form with the first layer/membrane; the structural substrate and the second layer/membrane may comprise a composite form.

The present invention relates to a composite structure for a component for vehicle interior comprising a structural substrate and a cover; the cover may comprise a base layer and a cover layer; the base layer may be provided between the structural substrate and the cover layer; the composite structure may be produced by a method comprising the steps of providing substrate material and/or cover layer material and/or base layer material, softening the substrate material and providing the cover on the substrate material comprising the base layer material and the cover layer material; the method may further comprise the step of providing barrier layer material and intermediate layer material; the method may further comprise the step of combining barrier layer material with the base layer material; the method may further comprise the step of molding the base layer of the cover with the substrate material; the method may further comprise the step of injection molding the cover layer material onto the barrier layer; the method may further comprise the step of heating the first layer/membrane material and the cover/base layer material to a temperature between 5 deg C. and 40 deg C. above the melting point of the layer/membrane material and/or adding an adhesive film between a first film material and the cover/base layer material and heating to a temperature higher than the melting point of the adhesive film but lower than the melting point of the first film material; the first layer/membrane material may comprise thermoplastic polyurethane elastomer and thermoplastic polyester elastomer; the adhesive film may comprise polyethylene adhesive film and/or polyamide adhesive film and/or polyester adhesive film, etc.; the method may further comprise the step of providing a structural substrate material and a cover layer material; the cover layer material may comprise a foaming agent; the method may further comprise the step of softening the structural substrate material; the method may further comprise the step of molding the pre-treated/heated softened structural substrate material to obtain a structural substrate; the method may further comprise the step of injection molding a cover layer material onto the surface of the structural substrate and then foaming; the structural substrate material may comprise hemp fiberboard and/or foamed hemp fiberboard and/or foamed glass fiberboard and/or polypropylene and/or polyimide and/or polycarbonate, etc.; the cover/base layer material may comprise polyethylene terephthalate fiber nonwoven fabric and/or three-dimensional mesh fabric and/or sponge and/or thermoplastic polyester elastomer and/or the intermediate foam layer may be formed by foaming thermoplastic polyester elastomer, etc.; the cover layer material may comprise thermoplastic polyester elastomer and/or a self-skinned surface formed after foaming and/or thermoplastic vulcanized rubber and/or polyurethane, etc.; the structural substrate material may comprise hemp fiberboard; the cover layer material may comprise thermoplastic polyester elastomer; the structural substrate material may be pre-treated/heated softened by heating; the heating temperature may be 200 deg C.-250 deg C. and/or the heating time may be 2 to 7 minutes; the component such as vehicle trim may include a dashboard and/or a door panel trim and/or a seat back panel and/or a steering wheel cover and/or a passenger dashboard armrest cover; the component may comprise a vehicle interior component; the component may comprise a dashboard component and/or a door panel component and/or a seat back component and/or a steering wheel component and/or an armrest component; the composite structure may comprise a component of an interior of a vehicle; the vehicle may comprise automobiles and/or airplanes and/or ships and/or bicycles and/or trams and/or trains and/or subways and/or light rail.

### FIGURES

FIG. 1A is a schematic perspective view of a vehicle according to an exemplary embodiment.

FIG. 1B is a schematic perspective view of a vehicle interior according to an exemplary embodiment.

FIG. 2 is a schematic side elevation view of a vehicle interior according to an exemplary embodiment.

FIG. 3 is a schematic perspective view of a component for a vehicle interior according to an exemplary embodiment.

FIG. 4 is a schematic side elevation view of a component for a vehicle interior according to an exemplary embodiment.

FIG. 5 is a schematic side elevation view of a component for a vehicle interior according to an exemplary embodiment.

FIG. 6 is a schematic side elevation view of a component for a vehicle interior according to an exemplary embodiment.

FIG. 7A is a schematic side elevation view of a component for a vehicle interior according to an exemplary embodiment.

FIG. 7B is a schematic side elevation view of a component for a vehicle interior according to an exemplary embodiment.

FIG. 8 is a schematic side elevation view of a component for a vehicle interior according to an exemplary embodiment.

FIG. 9 is a schematic side elevation view of a component for a vehicle interior according to an exemplary embodiment.

FIG. 10 is a schematic side elevation view of a component for a vehicle interior according to an exemplary embodiment.

FIG. 11 is a schematic side elevation view of a component for a vehicle interior according to an exemplary embodiment.

FIG. 12 is a schematic side elevation view of a component for a vehicle interior according to an exemplary embodiment.

FIG. 13A is a schematic perspective view of a composite structure for a component for a vehicle interior according to an exemplary embodiment.

FIG. 13B is a schematic perspective exploded view of a composite structure for a component for a vehicle interior according to an exemplary embodiment.

FIG. 13C is a schematic side elevation view of a composite structure for a component for a vehicle interior according to an exemplary embodiment.

FIG. 14A is a schematic side elevation view of a composite structure for a component for a vehicle interior according to an exemplary embodiment.

FIG. 14B is a schematic side elevation exploded view of a composite structure for a component for a vehicle interior according to an exemplary embodiment.

FIG. 14C is a schematic perspective view of a composite structure for a component for a vehicle interior according to an exemplary embodiment.

FIG. 14D is a schematic perspective exploded view of a composite structure for a component for a vehicle interior according to an exemplary embodiment.

FIG. 15A is a schematic side elevation view of a composite structure for a component for a vehicle interior according to an exemplary embodiment.

FIG. 15B is a schematic side elevation exploded view of a composite structure for a component for a vehicle interior according to an exemplary embodiment.

FIG. 15C is a schematic perspective view of a composite structure for a component for a vehicle interior according to an exemplary embodiment.

FIG. 15D is a schematic perspective exploded view of a composite structure for a component for a vehicle interior according to an exemplary embodiment.

FIG. 16A is a schematic perspective view of a composite structure for a component for a vehicle interior according to an exemplary embodiment.

FIG. 16B is a schematic perspective detail view of a composite structure for a component for a vehicle interior according to an exemplary embodiment.

FIG. 17A is a schematic perspective view of a composite structure for a component for a vehicle interior according to an exemplary embodiment.

FIG. 17B is a schematic perspective detail view of a composite structure for a component for a vehicle interior according to an exemplary embodiment.

FIG. 17C is a schematic perspective view of a composite structure for a component for a vehicle interior according to an exemplary embodiment.

FIG. 17D is a schematic perspective detail view of a composite structure for a component for a vehicle interior according to an exemplary embodiment.

FIG. 17E is a schematic side elevation detail view of a composite structure for a component for a vehicle interior according to an exemplary embodiment.

FIG. 17F is a schematic side elevation detail view of a composite structure for a component for a vehicle interior according to an exemplary embodiment.

FIGS. 18A through 19B are schematic perspective detail diagrams of a composite structure for a component for a vehicle interior according to an exemplary embodiment.

FIG. 20A is a schematic perspective view of a composite structure for a component for a vehicle interior according to an exemplary embodiment.

FIGS. 20B and 20C are schematic perspective views of a composite structure for a component for a vehicle interior according to an exemplary embodiment.

FIGS. 21A through 21C are schematic side elevation detail section views of a composite structure for a component for a vehicle interior according to an exemplary embodiment.

FIGS. 22A and 22B are schematic side elevation detail section views of a composite structure for a component for a vehicle interior according to an exemplary embodiment.

FIGS. 23A through 24 are schematic side elevation detail section views of a composite structure for a component for a vehicle interior according to an exemplary embodiment.

FIGS. 23A through 23C are schematic side elevation detail section views of a composite structure for a component for a vehicle interior according to an exemplary embodiment.

FIG. 24 is a schematic perspective view of a composite structure for a component for a vehicle interior according to an exemplary embodiment.

FIGS. 25A through 25C are schematic perspective views of a method for producing a composite structure for a component for a vehicle interior according to an exemplary embodiment.

FIG. 26 is a schematic perspective view of a composite structure for a component for a vehicle interior according to an exemplary embodiment.

FIG. 27A is a schematic perspective view of a composite structure for a component for a vehicle interior according to an exemplary embodiment.

FIG. 27B is a schematic side elevation view of a composite structure for a component for a vehicle interior according to an exemplary embodiment.

FIG. 28A is a schematic perspective view of a composite structure for a component for a vehicle interior according to an exemplary embodiment.

FIG. 28B is a schematic side elevation view of a composite structure for a component for a vehicle interior according to an exemplary embodiment.

FIG. 29A is a schematic perspective view of a composite structure for a component for a vehicle interior according to an exemplary embodiment.

FIG. 29B is a schematic side elevation view of a composite structure for a component for a vehicle interior according to an exemplary embodiment.

FIG. 29C is a schematic perspective view of a composite structure for a component for a vehicle interior according to an exemplary embodiment.

FIGS. 30A and 30B are schematic perspective views of a composite structure for a component for a vehicle interior according to an exemplary embodiment.

FIGS. 31A and 31B are schematic perspective views of a method of producing a composite structure for a component for a vehicle interior according to an exemplary embodiment.

FIGS. 31C and 31D are schematic perspective views of a composite structure for a component for a vehicle interior according to an exemplary embodiment.

FIGS. 32A and 32B are schematic perspective views of a method of producing a composite structure for a component for a vehicle interior according to an exemplary embodiment.

FIG. 33 is a schematic side elevation detail section views of a composite structure for a component for a vehicle interior according to an exemplary embodiment.

FIG. 34 is a schematic side elevation detail section views of a composite structure for a component for a vehicle interior according to an exemplary embodiment.

FIG. 35 is a schematic side elevation detail section views of a composite structure for a component for a vehicle interior according to an exemplary embodiment.

### DESCRIPTION

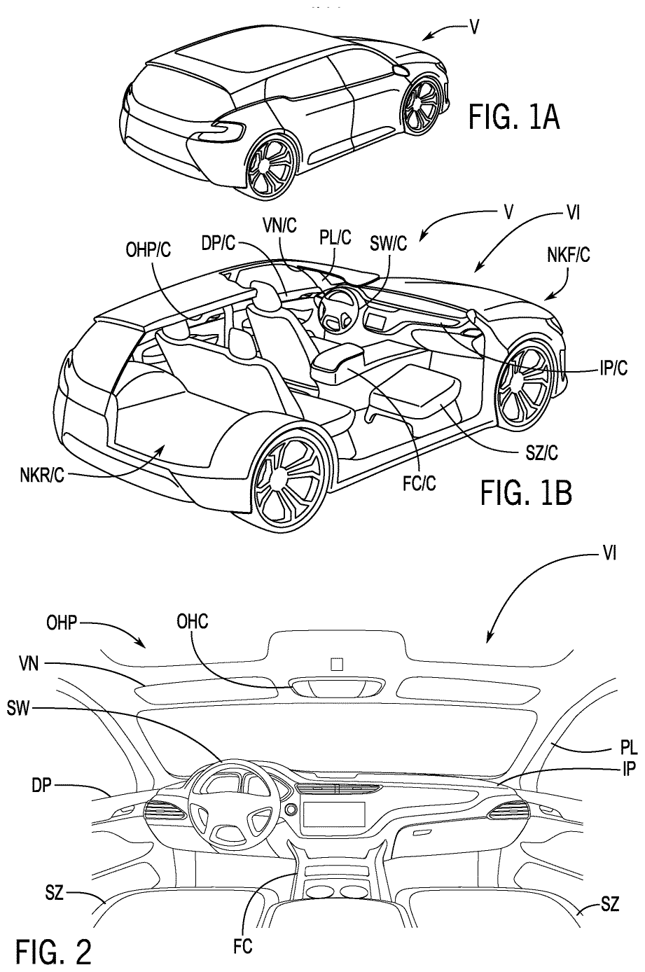

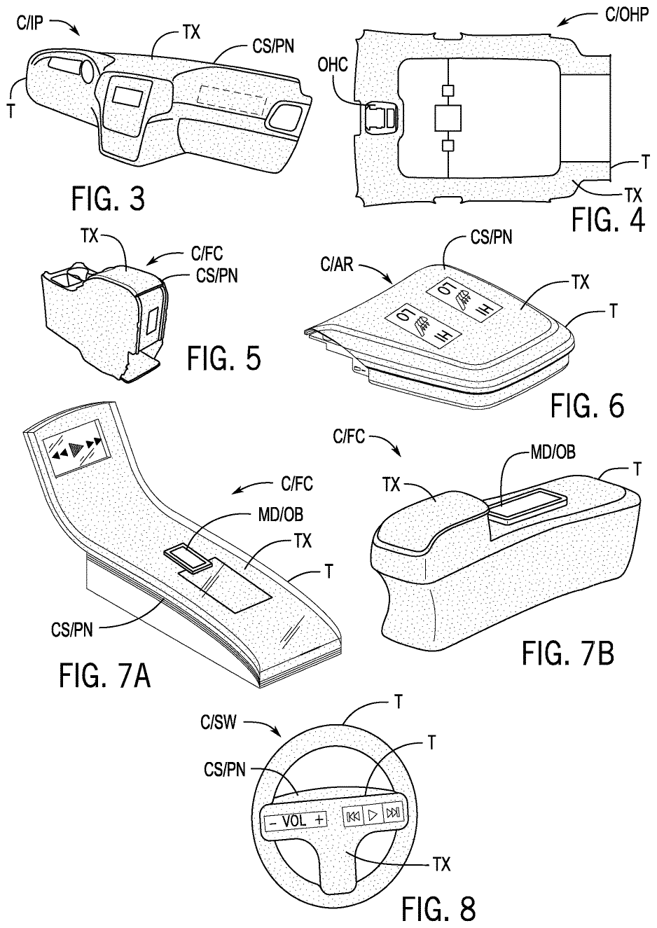

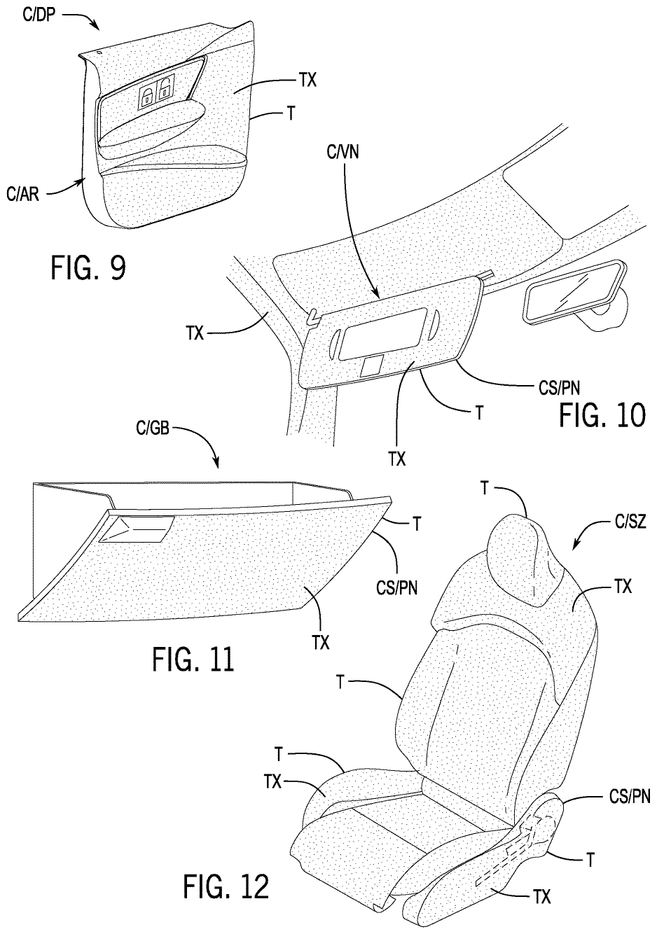

Referring to FIGS. 1A and 2A, a vehicle V with a vehicle interior VI comprising components C is shown according to an exemplary embodiment. As indicated schematically according to an exemplary embodiment in FIGS. 1B, 2, 3, 4, 5, 6, 7A-7B, 8, 9, 10, 11 and 12, components C for the vehicle interior may comprise an instrument panel IP, overhead system/console OHS/OHC, console such as floor console FC, door panel DP, pillar PL, vanity, VN, storage compartment GB, seat assembly SZ, etc. As indicated in FIGS. 3, 4, 5, 6, 7A-7B, 8, 9, 10, 11, 12, and 13A-13C, component C may comprise a composite structure CS comprising a substrate/base shown as structural substrate SB and a cover comprising a base layer T and a cover layer TX configured to provide an exterior surface. See also FIGS. 1B and 2.

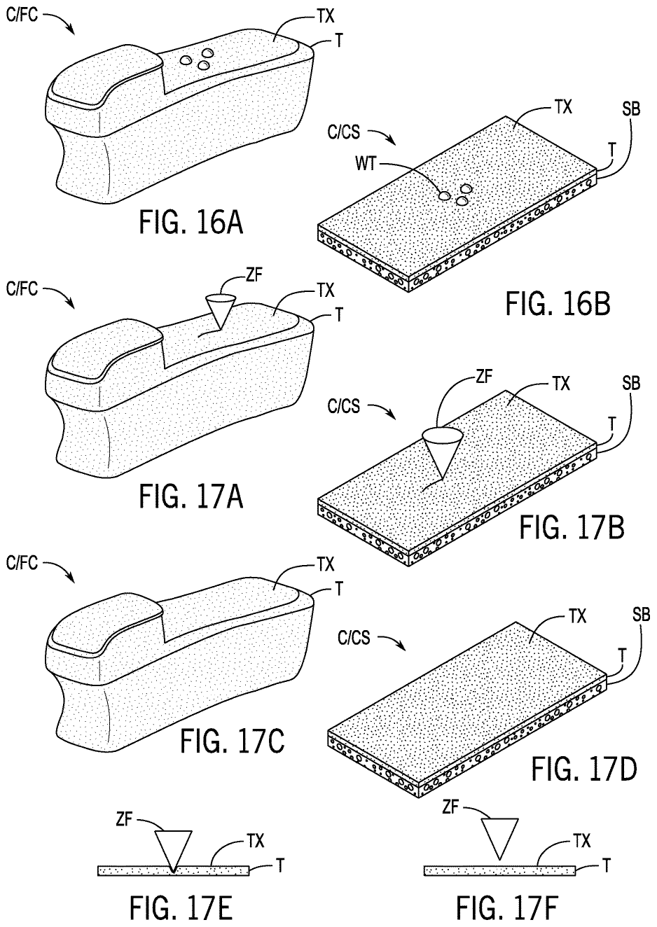

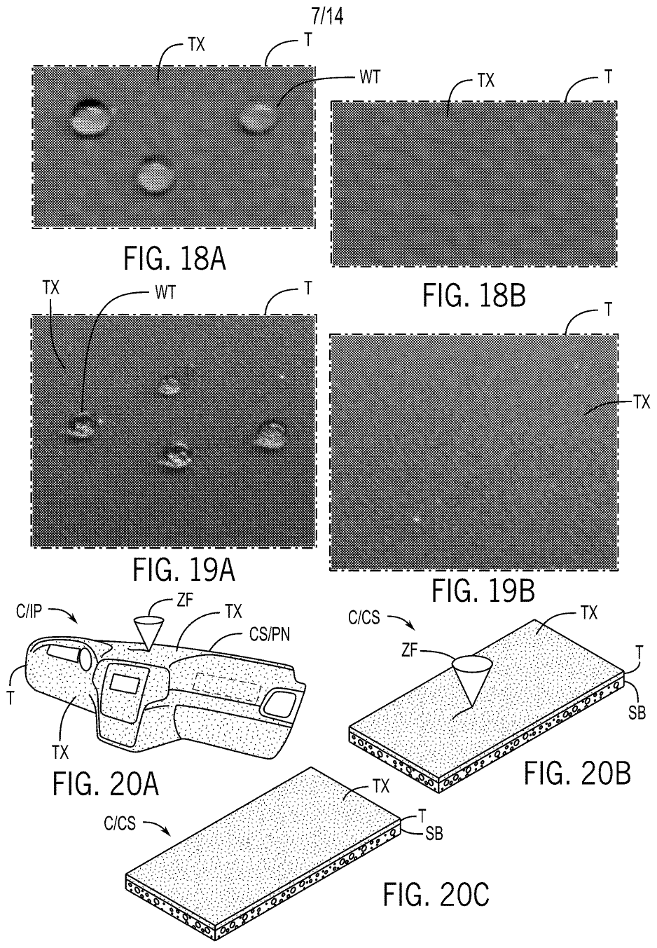

As indicated schematically in FIGS. 3, 4, 5, 6, 7A-7B, 8, 9, 10, 11, 12, 16A-16B, 17A-17F, 18A-18B, 19A-19B and 20A-20C, the composite structure CS with substrate SB and cover comprising base layer T and cover layer TX may be configured/formed to provide a surface effect such as visual effect and/or performance effect. See also FIGS. 3, 4, 5, 6, 7A-7B, 8, 9, 10, 11, 12, and 13A-13C. As indicated schematically in FIGS. 16A-16B, 17A-17F, 18A-18B, 19A-19B and 20A-20C, the composite structure CS with cover comprising base layer T and cover layer TX may provide a surface effect providing a visual effect such as a decorative effect, texture effect, color effect, etc. and/or a performance effect such as durability/wear resistance, scratch resistance, stain resistance, liquid repellence, anti-fouling, touch-feel/tactile performance, hardness/softness, friction coefficient, adhesion, etc. See also FIGS. 1B, 2, 3, 4, 5, 6, 7A-7B, 8, 9, 10, 11 and 12. As indicated schematically in FIGS. 16A-16B, 18A-18B and 19A-19B, the composite structure CS with cover comprising base layer T and cover layer TX may provide a surface effect providing a visual effect such as a decorative effect, texture effect, color effect, etc. and/or a performance effect such as stain resistance, liquid repellence, anti-fouling, etc. As indicated schematically in FIGS. 17A-17F and 20A-20C, the composite structure CS with cover comprising base layer T and cover layer TX may provide a surface effect providing a visual effect such as a decorative effect, texture effect, color effect, etc. and/or a performance effect such as durability/wear resistance, scratch resistance, touch-feel/tactile performance, hardness/softness, friction coefficient, adhesion, etc.

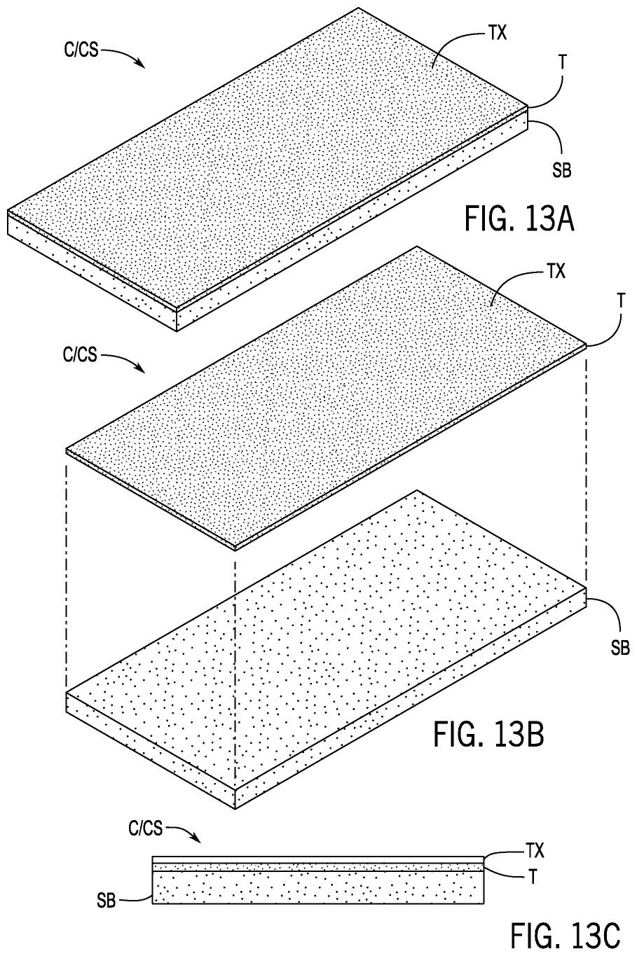

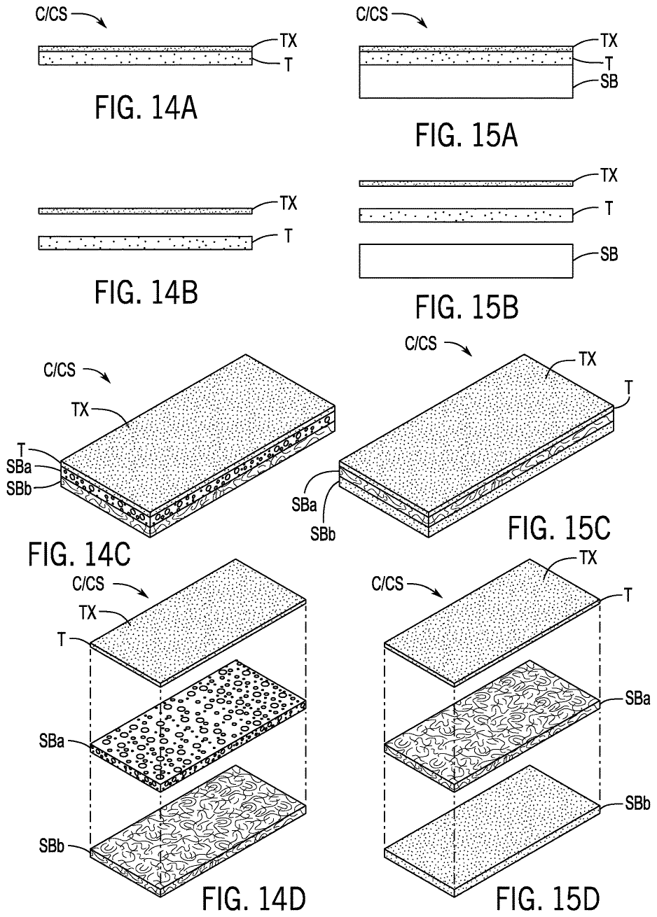

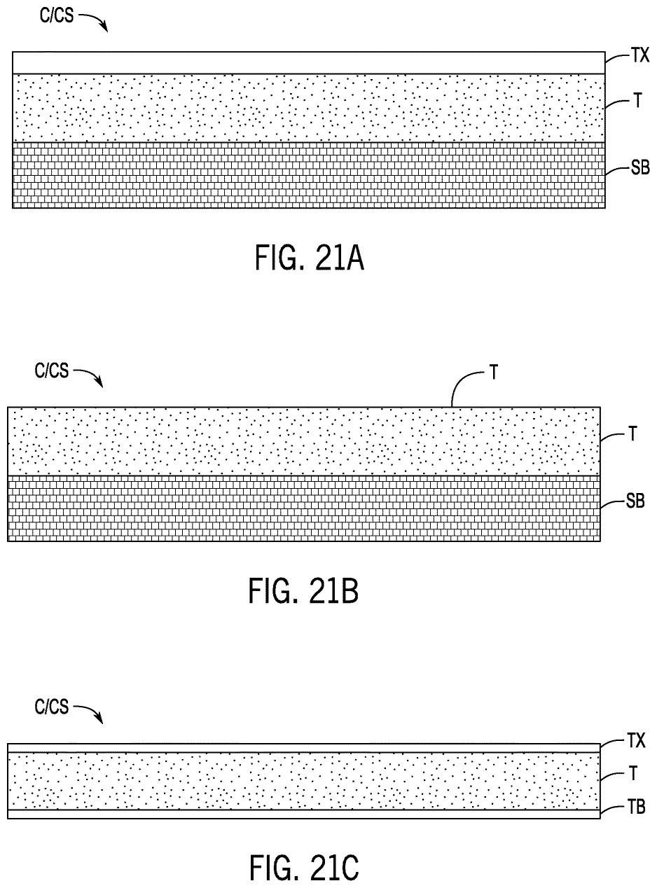

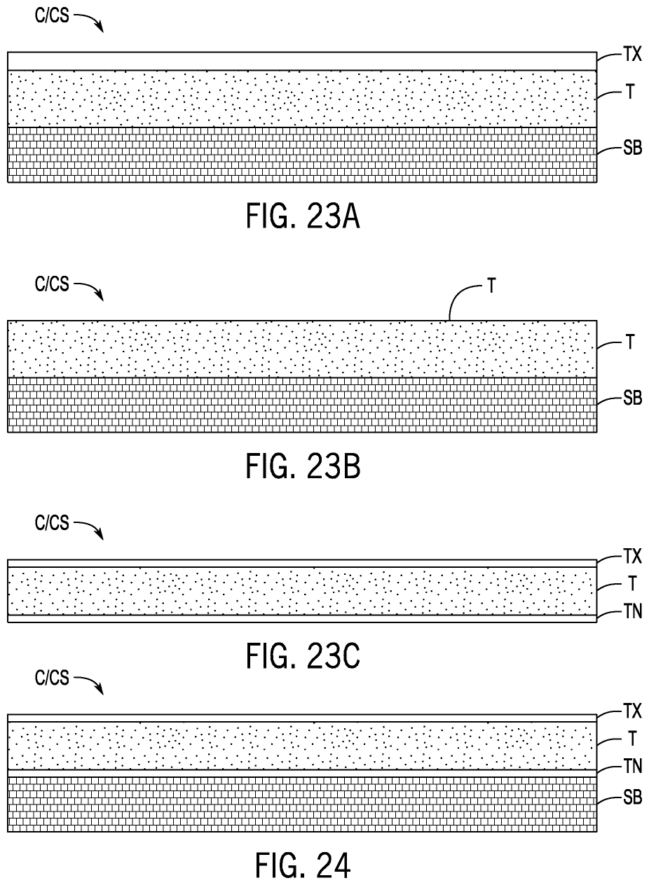

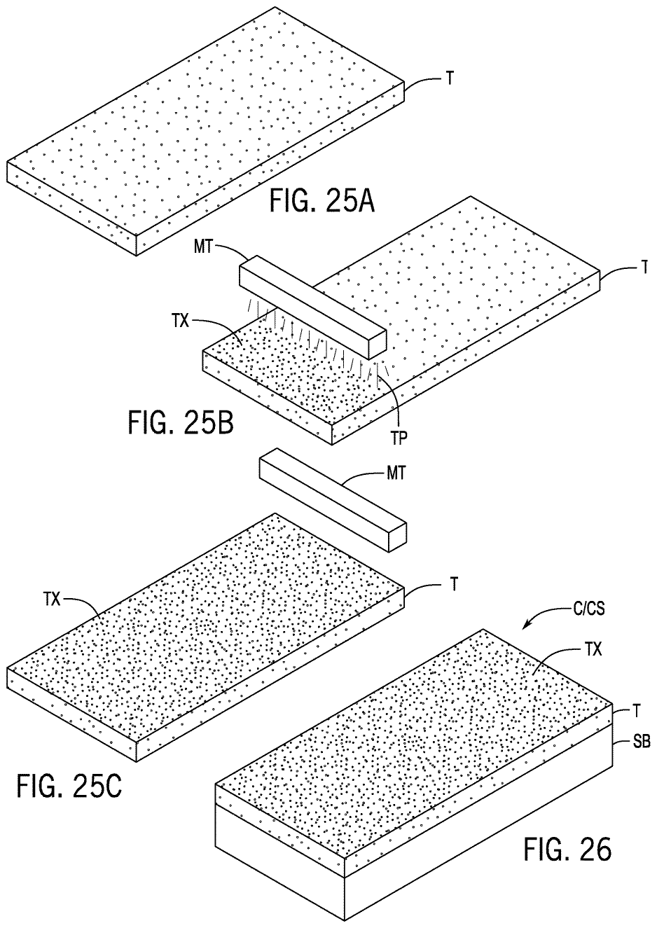

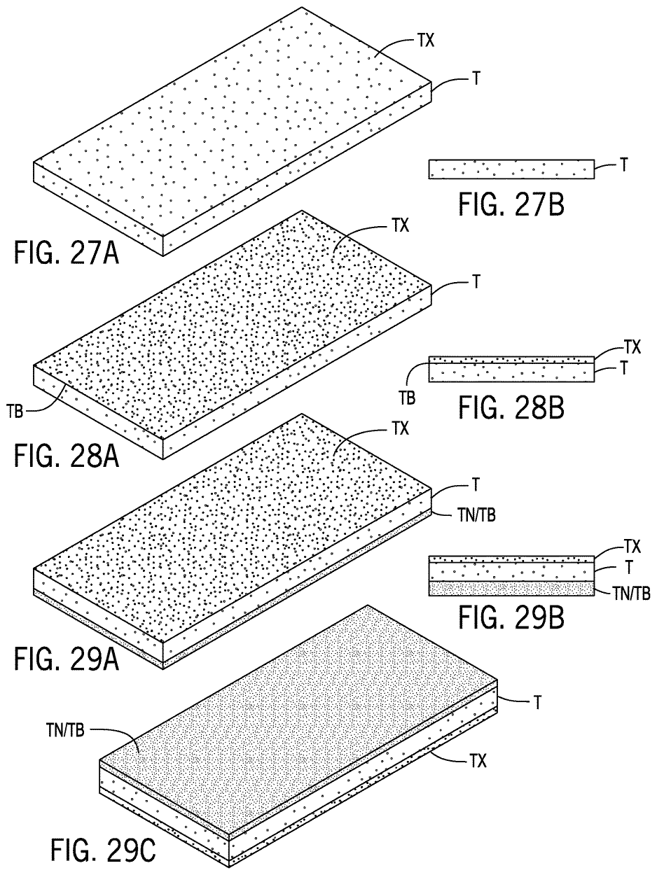

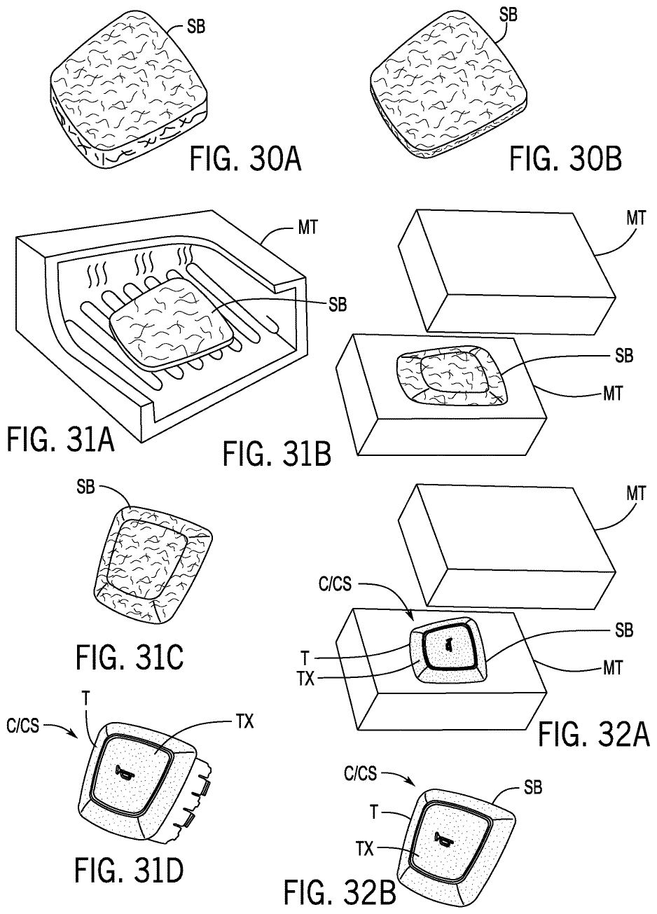

As indicated schematically in FIGS. 13A-13C, 14A-14D, 15A-15D, 21A-21C, 22A-22B, 23A-23C, 24, and 26, the cover layer TX may comprise an applied material, formed/molded material, coating, treatment, laminate, film, etc.; the base layer T may comprise a formed/molded material, polymer material, thermoplastic elastomer, foam/soft material, etc.; the composite structure CS may comprise a multi-layer structure comprising a polymer/PET material, fabric layer, non-woven layer, formed/molded materials, soft/cushion layer, barrier/intermediate layer TN in/at the cover, coating/treatment layer, etc.; the substrate SB may comprise a structure, formed/molded structure, panel, formed/molded panel, fiber panel, foam/resilient panel, composite panel, etc. See also FIGS. 27A-27B, 28A-28B, 29A-29C, 31D, 32B, 33, 34 and 35. As indicated schematically in FIGS. 25A-25C, the composite structure CS comprising the cover comprising base layer T and cover layer TX may be produced by application of the cover layer TX as a coating TP from a tool shown as comprising spray head MX. As indicated schematically in FIGS. 30A-30B, 31A-31D and 32A-32B, the composite structure CS comprising the cover comprising base layer T and cover layer TX may be produced by forming of the cover layer TX in a tool shown as comprising a mold MX; as indicated schematically, the substrate SB may be pre-heated to be formed into the structural substrate in the tool shown as oven MX (see FIG. 31A); as indicated schematically, the substrate SB may be compression formed and/or molded into a structural substrate in the tool shown as mold MX (see FIG. 31B); the cover comprising base layer T and cover layer TX may be formed in the tool shown as mold MX such as by injection molding, compression molding, compression forming, etc. (see FIG. 32A); the cover comprising base layer T and cover layer TX may be formed on the substrate SB in the tool shown as mold MX such as by injection molding, compression molding, etc. (see FIG. 32A); surface effect of the cover comprising base layer T and cover layer TX may be formed and/or imparted by the tool shown as mold MX (e.g. shape, form, texture, hardness/softness, color, etc.). See FIGS. 1B, 2, 3, 4, 5, 6, 7A-7B, 8, 9, 10, 11 and 12, 31D and 32B.

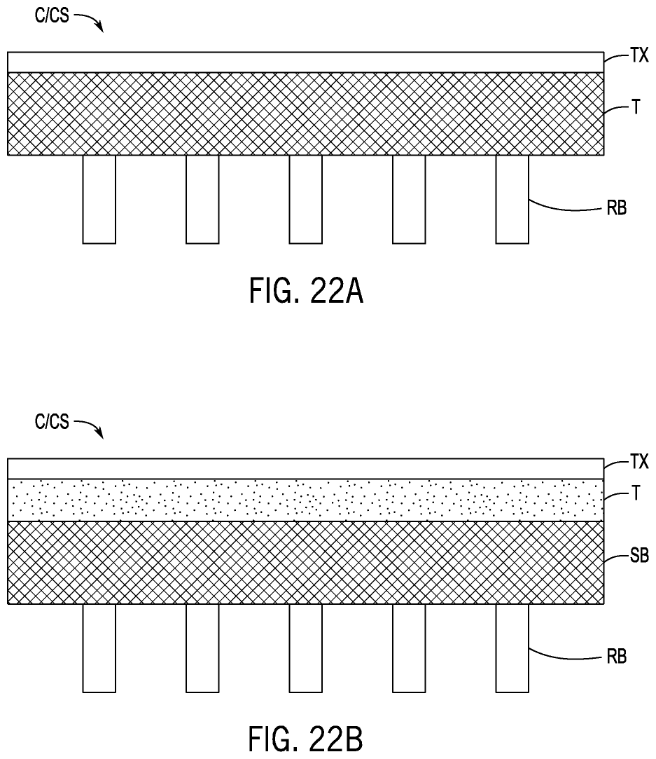

As indicated schematically in FIGS. 28A and 28B, the composite structure CS comprising the cover comprising cover base layer T and cover layer TX may comprise a barrier layer TB between the base layer T and the cover layer TX. See also FIGS. 29A-29B (barrier layer between cover and substrate); as indicated schematically, the barrier layer TB may comprise a material configured to limit penetration of material of the cover layer TX into material of the base layer T during formation of the cover; the barrier layer TB may comprise a material having compatibility with material of the cover layer TX; and the barrier layer TB may comprise a laminate with the base layer T. As indicated schematically in FIGS. 29A-29C, the composite structure CS comprising the cover comprising cover base T and cover layer TX may comprise an intermediate layer TN between cover base T and the substrate SB. As indicated schematically in FIGS. 22A-22B, the composite structure may comprise structure such a formed structure RB for the base layer T cover (see FIG. 22A) and/or for the substrate SB (see FIG. 22B).

As shown schematically in the FIGURES, the component C comprising may comprise a composite structure CS comprising a structural substrate SB and a cover comprising a base layer T and a cover layer TX; the base layer T of the cover may be configured to provide a base for the cover; the cover layer TX of the cover may be configured to provide an exterior surface for the composite structure CS; the cover layer TX of the cover may comprise a cover layer material on the base layer T of the cover; the cover layer material may comprise an applied material and/or a formed material; the base layer T of the cover may comprise a base layer material. The composite structure CS may comprise an interface between the structural substrate SB and the cover the interface may comprise an intermediate layer TN; the cover layer material may comprise an applied material comprising a coating; the cover layer TX may comprise a molded layer and/or an injection molded layer and/or a foam molded layer and/or a cover layer; the base layer T may comprise a molded layer; the base layer material may comprise a polymer material and/or a molded material and/or an injection-molded material and/or a film and/or a polymer material and/or an elastomer and/or a thermoplastic elastomer and/or at least one of TPEE and/or TPU and/or TPV and/or TPE-S; the cover layer TX may comprise a molded layer; the cover layer TX may comprise a polymer material and/or a molded material and/or an injection-molded material and/or a film and/or a polyurethane material and/or an acrylic material comprising silicone and/or a polymer material comprising fluorine and/or a stain-resistant polymer material; the structural substrate SB may comprise a panel and/or a base and/or a fiber panel and/or a compressed fiber panel and/or a reduced-density material and/or a stiffness-retaining material and/or a molded substrate SB; the intermediate layer TN may comprise a resilient material and/or a compressible material and/or a cushioning material and/or a foam material and/or a foam-based material and/or a film; the cover may be configured to provide a surface effect comprising a visual effect and/or a performance effect; the performance effect may comprise stain resistance and/or fluid repellence and/or hardness and/or scratch resistance and/or tactile performance; the structural substrate SB may comprise hemp fiberboard and/or foamed hemp fiberboard and/or foamed glass fiberboard and/or polypropylene and/or polyimide and/or polycarbonate; the base layer T may comprise a polyethylene terephthalate fiber material and/or a nonwoven fabric material and/or a mesh fabric and/or foam material and/or sponge material and/or thermoplastic polyester elastomer and/or a foamed material and/or polyethylene terephthalate fiber nonwoven fabric; the cover layer TX may comprise thermoplastic polyester elastomer and/or thermoplastic vulcanized rubber and/or polyurethane and/or a self-skinned material formed from thermoplastic polyester elastomer; the barrier layer TB may comprise polypropylene and/or polyethylene and/or polyethylene terephthalate and/or thermoplastic polyurethane elastomer and/or thermoplastic polyester elastomer; the barrier layer TB may comprise a material configured to limit penetration of material of the cover layer TX into material of the base layer T during formation of the cover; the barrier layer TB may comprise a material having compatibility with material of the cover layer TX; and the barrier layer TB may comprise a laminate with the base layer T; the interface layer may comprise polypropylene and/or polyethylene and/or polyethylene terephthalate and/or thermoplastic polyurethane elastomer and/or thermoplastic polyester elastomer; the interface layer may comprise a laminate with the structural substrate SB; the cover layer material may comprise antifouling coating characteristics; the surface effect may comprise adhesion evaluation and/or wear resistance and/or stain resistance evaluation and/or water droplet angle and/or feel evaluation and/or static and/or dynamic friction coefficient; the component C may be produced by a method comprising the steps of: providing the base layer material for the cover, providing the cover layer material for the cover on the base layer T of the cover, and providing the cover on the structural substrate SB; the step of providing the cover layer material for the cover on the base layer T of the cover may comprise forming the cover layer material on the base layer T; the step of providing the base layer material for the cover may comprise forming the base layer T from the base layer material on the structural substrate SB; the method may further comprise the step of forming a barrier layer TB between the base layer T and the cover layer TX to form a layer structure.

### Exemplary Embodiments—A

According to an exemplary embodiment as shown schematically in FIGS. 1B, 2, 3, 4, 5, 6, 7A-7B, 8, 9, 10, 11, 12, 16A-16B, 17A-17F, 18A-18B, 19A-19B and 20A-20C, a component C for a vehicle interior comprising a composite structure CS may comprise a substrate/base SB and cover comprising a base layer T a cover layer TX configured to provide a surface effect such as visual effect and/or performance effect for the component. See also FIGS. 13C, 14A-14D, 15A-15D, 21A-21C, 22A-22B, 23A-23C, 24, 27A-27B, 28A-28B, 29A-29C, 33, 34 and 35. The cover layer/material may comprise an applied material, formed/molded material, coating, treatment, laminate, film, etc.; the base layer/material may comprise a formed/molded material, polymer material, thermoplastic elastomer, foam/soft material, etc. The composite structure may comprise a multi-layer structure comprising a polymer, material, PET material, fabric layer, non-woven layer, formed/molded materials, soft/cushion layer, barrier/intermediate layer in/at the cover, coating/treatment layer, etc. The substrate may comprise a structure, formed/molded structure, panel, formed/molded panel, fiber panel, foam/resilient panel, composite panel, etc. As indicated schematically in FIGS. 16A-16B, 17A-17F, 18A-18B, 19A-19B and 20A-20C, the surface effect for the component comprising the composite structure with cover comprising base layer and cover layer may comprise durability/wear resistance, scratch resistance, stain resistance, liquid repellence, anti-fouling, touch-feel/tactile performance, hardness/softness, friction coefficient, adhesion, decorative/color effect, etc.

According to an exemplary embodiment as indicated schematically in FIGS. 13C, 14A-14D, 15A-15D, 21A-21C, 22A-22B, 23A-23C, 24, 27A-27B, 28A-28B, 29A-29C, 33, 34 and 35, a component C for a vehicle interior may comprise a composite structure CS shown as a multilayer material comprising a substrate/base SB/100 shown as a structural substrate such as a lightweight skeleton/structure and a cover comprises a base layer T such as a resilient/soft layer and a cover layer TX such as a skin layer; the base layer T may be provided between the structural substrate SB and the cover layer TX; the base layer T may be formed by molding such as injection molding and/or as a layer, etc.; the cover layer TX may be formed by molding such as injection molding and/or as a film/coating, etc.; a layer/membrane such as a barrier layer TB may be provided between the base layer T and the cover layer TX of the cover; a layer/membrane such as an intermediate layer TN may be provided between the substrate SB and the base layer T of the cover; the structural substrate SB may be provided as a base/structure such as a panel such as a fiber panel and/or formed by molding such as injection molding, foam injection molding, and or as a multi-layer substrate with layer SBa and SBb, etc.; the composite structure may comprise structure such a formed structure RB for the base layer T cover (see FIG. 22A) and/or for the substrate SB (see FIG. 22B). See also FIGS. 26, 31D and 32B.

According to an exemplary embodiment as indicated schematically in FIGS. 25A-25C, 30A-30B, 31A-31B and 32A-32B, a method may be provided for preparing the composite structure such as the multilayer material comprising the substrate such as the lightweight skeleton/structure material and the cover comprising the base layer such as the resilient soft layer material and the cover layer such as the skin layer material and/or with layer/membrane material; the substrate material may be heated/prepared such as heating/softening; the cover/layer material and/or membrane/layer material may be combined/formed onto the substrate for the composite structure; the substrate such as the pre-treated/heated softened lightweight skeleton material may be molded with the base/soft layer and/or with the layer/membrane of the cover to provide the composite structure for the component as a multilayer material; the method may comprise the step of applying, forming, molding, injection molding, etc. the cover comprising the base layer material and/or the cover layer material and/or the layer/membrane material for the substrate such as the lightweight structure/skeleton. See also FIGS. 26, 31D and 32B. The substrate material and/or the cover of the base layer material and/or the cover layer material and/or the layer/membrane/diaphragm/layer material may comprise a forming/foaming agent and/or a polymer material and/or materials to provide desired properties for the composite structure/combination. A cover/skin layer material may be applied, formed, molded/injection molded for the cover as the exterior surface of the composite structure with the substrate such as lightweight skeleton; the cover material may comprise an applied/formed/foamed material on the substrate of the composite structure.

### Exemplary Embodiments—B

According to an exemplary embodiment as shown schematically in the FIGURES, a component may comprise a composite structure comprising a cover and a structural substrate; the cover may comprise a base layer and a cover layer; the base layer of the cover may be configured to provide a base for the cover; the cover layer of the cover may be configured to provide an exterior surface for the composite structure; the cover layer of the cover may comprise a cover layer material on the base layer of the cover; the cover layer material may comprise an applied material and/or a formed material; the base layer of the cover may comprise a base layer material; the composite structure may comprise an interface between the structural substrate and the cover. The interface may comprise an interface layer; the interface may comprise a barrier layer; the interface may comprise an intermediate layer; the cover may comprise the interface; the cover may comprise the intermediate layer; the intermediate layer of the cover may be provided between the structural substrate and the cover layer; the cover may comprise a barrier layer; the cover may comprise a coating; the cover may comprise a polymer material; the cover layer material of the cover layer may comprise a formed material; the cover layer material of the cover layer may comprise a molded material; the cover layer material may comprise an applied material; the applied material may comprise a coating; the cover layer may comprise a coating; the coating may comprise an applied coating; the applied coating may comprise a coating at the exterior surface; the cover may comprise a skin; the skin may comprise the cover layer; the cover layer may comprise a molded layer; the cover layer may comprise an injection molded layer; the cover layer may comprise a foam molded layer; the cover layer may comprise a cover layer; the cover layer may comprise a self-skinned layer; the cover layer material may comprise a self-skinned material; the base layer may comprise a resin; the base layer material may comprise a resin; the base layer may comprise a molded layer; the base layer may comprise an injection-molded layer; the base layer may comprise a polymer material; the base layer material may comprise a polymer material; the base layer material may comprise a molded material; the base layer material may comprise an injection-molded material; the base layer material may comprise a film; the base layer material may comprise a polymer material; the base layer material may comprise an elastomer; the base layer material may comprise a thermoplastic elastomer; the base layer material may comprise at least one of TPEE, TPU, TPV and or TPE-S.

According to an exemplary embodiment as shown schematically in the FIGURES, a component may comprise a composite structure comprising a cover and a structural substrate; the cover may comprise a base layer and a cover layer; the base layer of the cover may be configured to provide a base for the cover; the cover layer of the cover may be configured to provide an exterior surface for the composite structure; the cover layer of the cover may comprise a cover layer material on the base layer of the cover; the cover layer material may comprise an applied material and/or a formed material; the base layer of the cover may comprise a base layer material; the composite structure may comprise an interface between the structural substrate and the cover. The cover layer may comprise a resin; the cover layer material may comprise a resin; the cover layer may comprise a molded layer; the cover layer may comprise an injection-molded layer; the cover layer may comprise a polymer material; the cover layer material may comprise a polymer material; the cover layer material may comprise a molded material; the cover layer material may comprise an injection-molded material; the cover layer material may comprise a polymer material; the cover layer material may comprise a film; the cover layer material may comprise a polyurethane material; the cover layer material may comprise an acrylic material; the cover layer may comprise an acrylic substrate; the cover layer material may comprise a polymer material comprising silicone; the cover layer material may comprise a polymer material comprising fluorine; the cover layer material may comprise a stain-resistant polymer material; the structural substrate may comprise a panel; the structural substrate may comprise a base; the structural substrate may comprise a fiber panel; the structural substrate may comprise a compressed fiber panel; the structural substrate may comprise a reduced-density material; the structural substrate may comprise a stiffness-retaining material; the structural substrate may comprise a molded substrate; the intermediate layer may comprise a resilient material; the intermediate layer may comprise a compressible material; the intermediate layer may comprise a cushioning material; the intermediate layer may comprise a foam material; the intermediate layer may comprise a foam-based material; the intermediate layer may comprise a film; the cover layer may comprise a polymer material; the intermediate layer may comprise a polymer material; the barrier layer may comprise a polymer material; the interface layer may comprise a polymer material; the cover layer may comprise a resistant layer; the cover layer may comprise a stain-resistant layer; the cover layer may comprise a resistant coating; the cover layer may comprise an anti-fouling coating; the cover layer may comprise a polyurethane material; the cover layer material may comprise a textured material; the external surface of the cover layer may comprise a textured surface; the external surface of the cover layer may comprise a patterned surface; the cover may be configured to provide a surface effect; the cover may be configured to provide a surface effect at the exterior surface; the surface effect may comprise a visual effect; the visual effect may comprise a decorative effect; the surface effect may comprise a performance effect; the performance effect may comprise stain resistance; the performance effect may comprise fluid repellence; the performance effect may comprise hardness; the performance effect may comprise scratch resistance; the performance effect may comprise tactile performance; tactile performance may comprise touch feel; the cover may be configured to provide a performance effect at the exterior surface; the performance effect may comprise tactile performance.

According to an exemplary embodiment as shown schematically in the FIGURES, a component may comprise a composite structure comprising a cover and a structural substrate; the cover may comprise a base layer and a cover layer; the base layer of the cover may be configured to provide a base for the cover; the cover layer of the cover may be configured to provide an exterior surface for the composite structure; the cover layer of the cover may comprise a cover layer material on the base layer of the cover; the cover layer material may comprise an applied material and/or a formed material; the base layer of the cover may comprise a base layer material; the composite structure may comprise an interface between the structural substrate and the cover. The structural substrate may comprise hemp fiberboard and/or foamed hemp fiberboard and/or foamed glass fiberboard and/or polypropylene and/or polyimide and/or polycarbonate; the structural substrate may comprise hemp fiberboard; the composite structure may comprise polyethylene terephthalate fiber nonwoven fabric and/or three-dimensional mesh fabric and/or foam and/or sponge and/or thermoplastic polyester elastomer and/or a foamed material; the cover may comprise polyethylene terephthalate fiber nonwoven fabric and/or three-dimensional mesh fabric and/or foam and/or sponge and/or thermoplastic polyester elastomer and/or a foamed material; the base layer may comprise a polyethylene terephthalate fiber material and/or a nonwoven fabric material and/or a mesh fabric and/or foam material and/or sponge material and/or thermoplastic polyester elastomer and/or a foamed material and/or polyethylene terephthalate fiber nonwoven fabric; the base layer may comprise polyethylene terephthalate fiber nonwoven fabric; the base layer may comprise three-dimensional mesh fabric; the base layer may comprise a foam layer; the base layer may comprise thermoplastic polyester elastomer; the base layer may comprise a foamed material formed from thermoplastic polyester elastomer; the cover layer may comprise thermoplastic polyester elastomer and/or thermoplastic vulcanized rubber and/or polyurethane; the cover layer may comprise thermoplastic polyester elastomer; the cover layer may comprise a self-skinned material formed from thermoplastic polyester elastomer; the barrier layer may comprise polypropylene and/or polyethylene and/or polyethylene terephthalate and/or thermoplastic polyurethane elastomer and/or thermoplastic polyester elastomer; the barrier layer may comprise thermoplastic polyurethane elastomer; the barrier layer may comprise thermoplastic polyester elastomer; the interface layer may comprise polypropylene and/or polyethylene and/or polyethylene terephthalate and/or thermoplastic polyurethane elastomer and/or thermoplastic polyester elastomer; the interface layer may comprise polyethylene; the barrier layer may comprise a material configured to limit penetration of material of the cover layer into material of the base layer during formation of the cover; the barrier layer may comprise a material having compatibility with material of the cover layer; the barrier layer may comprise a laminate with the base layer; the interface layer may comprise a laminate with the structural substrate; the structural substrate may comprise a thickness of 1.5 mm to 3 mm; the structural substrate may comprise a flexural modulus of at least 1800 MPa; the structural substrate may comprise a density of less than 0.85 g/cm\hat{ }3; the base layer may comprise a thickness of 0.5 mm to 3 mm; the base layer may comprise a Shore C hardness of 30 to 60; the cover layer may comprise a thickness of 0.4 mm to 1.2 mm; the cover layer may comprise a Shore A hardness of 40 to 80; the cover layer may comprise a density of 1.0 g/cm\hat{ }3 to 1.3 g/cm\hat{ }3; the cover layer material may comprise a coating film-forming resin and/or water-based acrylic resin and/or water-based polyurethane resin and/or coating auxiliary components and/or fluorine-containing polymers and/or silane-containing polymers, etc.; the cover layer material may comprise isocyanate and/or carbide diamine and/or a leveling agent and/or defoamer and/or color paste and/or antioxidant and/or UV resistant additive, etc.; the cover layer material may comprise may comprise antifouling coating characteristics and/or cross-linking density of the film-forming resin and/or acrylic resin and/or fluorine-containing polymers and/or silicon-containing polymer material, dry film thickness of coating: 3~30 μm, preferably 8~15 μm; the base layer material may comprise a thermoplastic resin and/or TPEE polyester elastomer and/or TPU polyurethane elastomer and/or TPV thermoplastic vulcanized elastomer and/or TPE-S thermoplastic styrene elastomer, etc.; the cover may be may be formed by thermoplastic forming and/or in-mold injection molding and/or in-mold foam injection molding and/or extrusion and calendering and/or slush process molding, etc.; the surface effect may comprise adhesion evaluation and/or wear resistance and/or stain resistance evaluation and/or water droplet angle and/or feel evaluation and/or static and dynamic friction coefficient, etc.

According to an exemplary embodiment as shown schematically in the FIGURES, a component comprising a composite structure may comprise a cover and a structural substrate; the cover may comprise a base layer and a cover layer; the base layer of the cover may be configured to provide a base for the cover; the cover layer of the cover may be configured to provide an exterior surface for the composite structure; the cover layer of the cover may comprise a cover layer material on the base layer of the cover; the cover layer material may comprise an applied material and/or a formed material; the base layer of the cover may comprise a base layer material; the composite structure may comprise an interface between the structural substrate and the cover. The component may be produced by a method comprising the steps of providing the base layer material for the cover and providing the cover layer material for the cover on the base layer of the cover; the method may further comprise the step of forming the structural substrate; the method may further comprise the step of providing the cover on the structural substrate; the step of providing the cover layer material for the cover on the base layer of the cover may comprise applying the cover layer material on the base layer; the step of providing the cover layer material for the cover on the base layer of the cover may comprise applying the cover layer material as a coating on the base layer; the step of providing the cover layer material for the cover on the base layer of the cover may comprise forming the cover layer material on the base layer; the method may further comprise the step of providing a barrier layer on the base layer of the cover; the barrier layer may be under the cover layer of the cover and on the base layer of the cover; the method may further comprise the step of providing an intermediate layer under the base layer of the cover; the intermediate layer may be formed on the structural substrate; the step of providing the base layer material for the cover may comprise forming the base layer from the base layer material on the structural substrate; the step of providing the base layer material for the cover may comprise molding the base layer on the structural substrate; the step of providing the base layer material for the cover may comprise injection molding the base layer on the structural substrate; the step of providing the cover layer material for the cover may comprise forming the cover layer from the cover layer material to provide the exterior surface for the composite structure; the method may further comprise the step of forming the barrier layer between the base layer and the cover layer; the method may further comprise the step of combining the barrier layer with the base layer to form a layer structure; the method may further comprise the step of forming the cover layer on the base layer; the method may further comprise the steps of providing the barrier layer on the base layer and forming the cover layer on the barrier layer; the method may further comprise the step of laminating the barrier layer on the base layer; the method may further comprise the step of forming the cover layer by foam injection molding; the method may further comprise the step of forming the cover layer by molding a self-cover layer on the base layer of the cover; the method may further comprise the step of assembling the structural substrate of the composite structure.

According to an exemplary embodiment as shown schematically in the FIGURES, a composite structure for a component for vehicle interior may comprise a structural substrate and a cover; the cover may comprise a base layer and a cover layer; the base layer may be provided between the structural substrate and the cover layer. The cover layer of the cover may be formed by injection molding and/or foam injection molding; a barrier layer may be provided between the base layer and the cover layer of the cover; the barrier layer may comprise a layer/membrane; the composite structure may comprise a multi-layer material; an intermediate layer may be provided between the structural substrate and the base layer of the cover; the intermediate layer may comprise a layer/membrane; the substrate of the composite structure may comprise a structural substrate and/or hemp fiberboard and/or foamed hemp fiberboard and/or foamed glass fiberboard and/or polypropylene and/or polyimide and/or polycarbonate, etc.; the base layer of the cover of the composite structure may comprise a cover/base layer and/or polyethylene terephthalate fiber nonwoven fabric and/or three-dimensional mesh fabric and/or sponge and/or thermoplastic polyester elastomer and/or intermediate foam layer formed by foaming thermoplastic polyester elastomer, etc.; the cover layer of the cover of the composite structure may comprise a cover layer and/or a thermoplastic polyester elastomer or a self-skinned surface formed therefrom after foaming and/or thermoplastic vulcanized rubber and/or polyurethane, etc.; the substrate may comprise a thickness of 1.5 mm-3 mm; the substrate may comprise a flexural modulus of over 1800 Mpa; the substrate may comprise a density of less than 0.85 g/cm\hat{ }3; the thickness of the base layer may be 0.5 mm-3 mm and/or the Shore hardness C may be 30-60 degrees; the cover layer may comprise a thickness of 0.4 mm-1.2 mm; the cover layer may comprise a Shore A hardness of 40-80; the cover layer may comprise a density of 1 g/cm\hat{ }3-1.3 g cm\hat{ }3; the barrier layer may comprise a layer/membrane and/or the intermediate layer may comprise a layer/membrane; each layer/membrane may comprise polypropylene and/or polyethylene and/or polyethylene terephthalate and/or thermoplastic polyurethane elastomer and/or thermoplastic polyester elastomer, etc.; the cover may comprise a composite form comprising at least two layers; the substrate and the base layer may be provided in a composite form; the composite structure may comprise a structural substrate; the cover layer may comprise a skin; the base layer may comprise a cover/base layer; the cover/base layer may be between the structural substrate and the skin; the skin may comprise a cover layer formed by injection molding and/or foam injection molding; the barrier layer may comprise a layer/membrane between the cover/base layer and the cover layer; the composite structure may comprise a multi-layer material; the cover of the composite structure may comprise a multi-layer material; the substrate of the composite structure may comprise a structural substrate and/or hemp fiberboard and/or foamed hemp fiberboard and/or foamed glass fiberboard and/or polypropylene and/or polyimide and/or polycarbonate, etc.; the base layer of the cover of the composite structure may comprise a cover/base layer may comprise polyethylene terephthalate fiber nonwoven fabric and/or three-dimensional mesh fabric and/or sponge and/or thermoplastic polyester elastomer and/or intermediate foam layer formed by foaming thermoplastic polyester elastomer; the cover layer of the cover of the composite structure may comprise a cover layer and/or a thermoplastic polyester elastomer and/or a self-skinned surface formed therefrom after foaming and/or thermoplastic vulcanized rubber and/or polyurethane; the composite structure may comprise a multi-layer material; the structural substrate may comprise a thickness of 1.5 mm-3 mm; the structural substrate may comprise a flexural modulus of over 1800 Mpa; the structural substrate may comprise a density of less than 0;85 g/cm; the thickness of the cover/base layer may be 0.5 mm-3 mm; the Shore hardness C of the cover/base layer may be 30-60 degrees; the cover layer may comprise a thickness of 0.4 mm-1.2 mm; the cover layer may comprise a Shore A hardness of 40-80; the cover layer may comprise a density of 1 g/cm\hat{ }3-1;3 g/cm\hat{ }3; the composite structure may comprise a multi-layer material; the barrier layer may comprise a first layer/membrane and the second layer/membrane; the first layer/membrane and the second layer/membrane may each independently comprise polypropylene and/or polyethylene and/or polyethylene terephthalate and/or thermoplastic polyurethane elastomer and/or thermoplastic polyester elastomer, etc.; the cover/base layer may comprise a composite form with the first layer/membrane; the structural substrate and the second layer/membrane may comprise a composite form.

According to an exemplary embodiment as shown schematically in the FIGURES, a composite structure for a component for vehicle interior may comprise a structural substrate and a cover; the cover may comprise a base layer and a cover layer; the base layer may be provided between the structural substrate and the cover layer; the composite structure may be produced by a method comprising the steps of providing substrate material and/or cover layer material and/or base layer material, softening the substrate material and providing the cover on the substrate material comprising the base layer material and the cover layer material; the method may further comprise the step of providing barrier layer material and intermediate layer material; the method may further comprise the step of combining barrier layer material with the base layer material; the method may further comprise the step of molding the base layer of the cover with the substrate material; the method may further comprise the step of injection molding the cover layer material onto the barrier layer; the method may further comprise the step of heating the first layer/membrane material and the cover/base layer material to a temperature between 5 deg C. and 40 deg C. above the melting point of the layer/membrane material and/or adding an adhesive film between a first film material and the cover/base layer material and heating to a temperature higher than the melting point of the adhesive film but lower than the melting point of the first film material; the first layer/membrane material may comprise thermoplastic polyurethane elastomer and thermoplastic polyester elastomer; the adhesive film may comprise polyethylene adhesive film and/or polyamide adhesive film and/or polyester adhesive film, etc.; the method may further comprise the step of providing a structural substrate material and a cover layer material; the cover layer material may comprise a foaming agent; the method may further comprise the step of softening the structural substrate material; the method may further comprise the step of molding the pre-treated/heated softened structural substrate material to obtain a structural substrate; the method may further comprise the step of injection molding a cover layer material onto the surface of the structural substrate and then foaming; the structural substrate material may comprise hemp fiberboard and/or foamed hemp fiberboard and/or foamed glass fiberboard and/or polypropylene and/or polyimide and/or polycarbonate, etc.; the cover/base layer material may comprise polyethylene terephthalate fiber nonwoven fabric and/or three-dimensional mesh fabric and/or sponge and/or thermoplastic polyester elastomer and/or the intermediate foam layer may be formed by foaming thermoplastic polyester elastomer, etc.; the cover layer material may comprise thermoplastic polyester elastomer and/or a self-skinned surface formed after foaming and/or thermoplastic vulcanized rubber and/or polyurethane, etc.; the structural substrate material may comprise hemp fiberboard; the cover layer material may comprise thermoplastic polyester elastomer; the structural substrate material may be pre-treated/heated softened by heating; the heating temperature may be 200 deg C.-250 deg C. and/or the heating time may be 2 to 7 minutes; the component such as vehicle trim may include a dashboard and/or a door panel trim and/or a seat back panel and/or a steering wheel cover and/or a passenger dashboard armrest cover; the component may comprise a vehicle interior component; the component may comprise a dashboard component and/or a door panel component and/or a seat back component and/or a steering wheel component and/or an armrest component; the composite structure may comprise a component of an interior of a vehicle; the vehicle may comprise automobiles and/or airplanes and/or ships and/or bicycles and/or trams and/or trains and/or subways and/or light rail.

### Exemplary Embodiments—C

According to an exemplary embodiment as shown schematically in FIGS. 1B, 2, 3, 4, 5, 6, 7A-7B, 8, 9, 10, 11, 12, 16A-16B, 17A-17F, 18A-18B, 19A-19B and 20A-20C, a component C for a vehicle interior comprising a composite structure CS may comprise a substrate/base SB and cover comprising a base layer T a cover layer TX configured to provide a surface effect such as visual effect and/or performance effect for the component. See also FIGS. 13C, 14A-14D, 15A-15D, 21A-21C, 22A-22B, 23A-23C, 24, 27A-27B, 28A-28B, 29A-29C, 33, 34 and 35. The cover layer/material may comprise an applied material, formed/molded material, coating, treatment, laminate, film, etc.; the base layer/material may comprise a formed/molded material, polymer material, thermoplastic elastomer, foam/soft material, etc. The composite structure may comprise a multi-layer structure comprising a polymer, material, PET material, fabric layer, non-woven layer, formed/molded materials, soft/cushion layer, barrier/intermediate layer in/at the cover, coating/treatment layer, etc. The substrate may comprise a structure, formed/molded structure, panel, formed/molded panel, fiber panel, foam/resilient panel, composite panel, etc. As indicated schematically in FIGS. 16A-16B, 17A-17F, 18A-18B, 19A-19B and 20A-20C, the surface effect for the component comprising the composite structure with cover comprising base layer and cover layer may comprise durability/wear resistance, scratch resistance, stain resistance, liquid repellence, anti-fouling, touch-feel/tactile performance, hardness/softness, friction coefficient, adhesion, decorative/color effect, etc.

According to an exemplary embodiment as indicated schematically in FIGS. 13C, 14A-14D, 15A-15D, 21A-21C, 22A-22B, 23A-23C, 24, 27A-27B, 28A-28B, 29A-29C, 33, 34 and 35, a component C for a vehicle interior may comprise a composite structure CS shown as a multilayer material comprising a substrate/base SB/100 shown as a structural substrate such as a lightweight skeleton/structure and a cover comprises a base layer T such as a resilient/soft layer and a cover layer TX such as a skin layer; the base layer T may be provided between the structural substrate SB and the cover layer TX; the base layer T may be formed by molding such as injection molding and/or as a layer, etc.; the cover layer TX may be formed by molding such as injection molding and/or as a film/coating, etc.; a layer/membrane such as a barrier layer TB may be provided between the base layer T and the cover layer TX of the cover; a layer/membrane such as an intermediate layer TN may be provided between the substrate SB and the base layer T of the cover; the structural substrate SB may be provided as a base/structure such as a panel such as a fiber panel and/or formed by molding such as injection molding, foam injection molding, and or as a multi-layer substrate with layer SBa and SBb, etc.; the composite structure may comprise structure such a formed structure RB for the base layer T cover (see FIG. 22A) and/or for the substrate SB (see FIG. 22B). See also FIGS. 26, 31D and 32B.

According to an exemplary embodiment as indicated schematically in FIGS. 25A-25C, 30A-30B, 31A-31B and 32A-32B, a method may be provided for preparing the composite structure such as the multilayer material comprising the substrate such as the lightweight skeleton/structure material and the cover comprising the base layer such as the resilient soft layer material and the cover layer such as the skin layer material and/or with layer/membrane material; the substrate material may be heated/prepared such as heating/softening; the cover/layer material and/or membrane/layer material may be combined/formed onto the substrate for the composite structure; the substrate such as the pre-treated/heated softened lightweight skeleton material may be molded with the base/soft layer and/or with the layer/membrane of the cover to provide the composite structure for the component as a multilayer material; the method may comprise the step of applying, forming, molding, injection molding, etc. the cover comprising the base layer material and/or the cover layer material and/or the layer/membrane material for the substrate such as the lightweight structure/skeleton. See also FIGS. 26, 31D and 32B. The substrate material and/or the cover of the base layer material and/or the cover layer material and/or the layer/membrane/diaphragm/layer material may comprise a forming/foaming agent and/or a polymer material and/or materials to provide desired properties for the composite structure/combination. A cover/skin layer material may be applied, formed, molded/injection molded for the cover as the exterior surface of the composite structure with the substrate such as lightweight skeleton; the cover material may comprise an applied/formed/foamed material on the substrate of the composite structure

As indicated schematically in the FIGURES, an exemplary embodiment provides a composite structure comprising: A structural substrate; a cover layer; and a cover/base layer between the structural substrate and the cover layer; the cover layer is formed by injection molding and a first layer/membrane is included between the cover/base layer and the cover layer; or the cover layer is formed by foam injection molding.

An exemplary embodiment provides a method for preparing a composite structure, comprising: structural substrate materials, cover layer materials, cover/base layer materials, and first layer/membrane materials; Soften the structural substrate material. The first layer/membrane material is combined with the cover/base layer material to obtain a cover/base layer with a layer/membrane.

The pre-treated/heated softened structural substrate material is molded with the cover/base layer with the layer/membrane to obtain a structural substrate with a cover/base layer.

The composite structure is obtained by injection molding a cover layer material onto the surface of the layer/membrane material with the cover/base layer of the structural substrate.

As indicated schematically in the FIGURES, an exemplary embodiment provides a method for preparing a composite structure, comprising: A structural substrate material and a cover layer material are provided; the cover layer material contains a foaming agent; Soften the structural substrate material. The pre-treated/heated softened structural substrate material is molded to obtain a structural substrate.

A cover layer material is injection molded onto the surface of the structural substrate and then foamed to obtain the composite structure.

As indicated schematically in the FIGURES, an exemplary embodiment provides a component such as vehicle trim comprising the composite structure of an exemplary embodiment and/or a composite structure prepared by the method of an exemplary embodiment.

As according to an exemplary embodiment as indicated schematically in the FIGURES, a vehicle is also provided that includes the component such as vehicle trim of an exemplary embodiment.

According to an exemplary embodiment as shown schematically in the FIGURES, a multi-layer material for component such as vehicle trim may comprise a structural substrate, a cover layer and a cover/base layer between the structural substrate and the skin; the cover layer may be formed by injection molding or foam injection molding; a first layer/membrane may be included between the cover/base layer and the cover layer; a second layer/membrane may be included between the structural substrate and the cover/base layer; the structural substrate may comprise hemp fiberboard and/or foamed hemp fiberboard and/or foamed glass fiberboard and/or polypropylene and/or polyimide and/or polycarbonate, etc.; the cover/base layer may comprise polyethylene terephthalate fiber nonwoven fabric and/or three-dimensional mesh fabric and/or sponge and/or thermoplastic polyester elastomer and/or an intermediate foam layer formed by foaming thermoplastic polyester elastomer, etc.; the cover layer may comprise a thermoplastic polyester elastomer and/or or a self-skinned surface formed therefrom after foaming and/or thermoplastic vulcanized rubber and/or polyurethane, etc.; the structural substrate may comprise a thickness of 1.5 mm-3 mm; the structural substrate may comprise a flexural modulus of over 1800 Mpa; the structural substrate may comprise a density of less than 0.85 g/cm\hat{ }3; the thickness of the cover/base layer may be 0.5 mm-3 mm; the cover/base layer may comprise a Shore hardness C of 30-60 degrees; the cover layer may comprise a thickness of 0.4 mm-1.2 mm; the cover layer may comprise a Shore A hardness of 40-80; the cover layer may comprise a density of 1 g/cm\hat{ }3-1.3 g/cm\hat{ }3; the first layer/membrane and the second layer/membrane may each comprise polypropylene and/or polyethylene and/or polyethylene terephthalate and/or thermoplastic polyurethane elastomer and/or thermoplastic polyester elastomer, etc.; the cover/base layer may comprise a composite form with the first layer/membrane; the structural substrate and the second layer/membrane may comprise a composite form.

According to an exemplary embodiment as shown schematically in the FIGURES, a multi-layer material for component such as vehicle trim may comprise a structural substrate, a cover layer and a cover/base layer between the structural substrate and the skin may be prepared by a method comprising providing structural substrate materials, cover layer materials, cover/base layer materials, and first layer/membrane materials; softening the structural substrate material; combining the first layer/membrane material with the cover/base layer material to obtain a cover/base layer with a layer/membrane; molding the pre-treated/heated softened structural substrate material with the cover/base layer with the layer/membrane to obtain a structural substrate with a cover/base layer; and injection molding a cover layer material onto the surface of the layer/membrane material with the cover/base layer of the structural substrate. The method may comprise heating the first layer/membrane material and the cover/base layer material to a temperature between 5 deg C. and 40 deg C. above the melting point of the layer/membrane material and/or or adding an adhesive film between the first film material and the cover/base layer material and heating to a temperature higher than the melting point of the adhesive film but lower than the melting point of the first film material; the first layer/membrane material may comprise thermoplastic polyurethane elastomer and/or thermoplastic polyester elastomer; the adhesive film may comprise polyethylene adhesive film and/or polyamide adhesive film and/or polyester adhesive film, etc.; the method may further comprise providing a structural substrate material and a cover layer material; the cover layer material may contain a foaming agent; the method may comprise softening the structural substrate material; the method may comprise molding the pre-treated/heated softened structural substrate material to obtain a structural substrate; the method may comprise injection molding a cover layer material onto the surface of the structural substrate and then foaming; the structural substrate material may comprise hemp fiberboard and/or foamed hemp fiberboard and/or foamed glass fiberboard and/or polypropylene and/or polyimide and/or polycarbonate, etc.; the cover/base layer material may comprise polyethylene terephthalate fiber nonwoven fabric and/or three-dimensional mesh fabric and/or sponge and/or thermoplastic polyester elastomer and/or an intermediate foam layer formed by foaming thermoplastic polyester elastomer, etc.; the cover layer material may comprise thermoplastic polyester elastomer or a self-skinned surface formed after foaming and/or thermoplastic vulcanized rubber and/or polyurethane, etc.; the structural substrate material may comprise hemp fiberboard; the cover layer material may comprise thermoplastic polyester elastomer; the structural substrate material may be pre-treated/heated softened by heating; the heating temperature may be 200 deg C.-250 deg C.; the heating time may be 2 to 7 minutes; the component such as vehicle trim may comprise a dashboard and/or door panel trim and/or a seat back panel and/or a steering wheel cover and/or a passenger dashboard armrest cover, etc.; the vehicle may comprise automobiles and/or airplanes and/or ships and/or bicycles and/or trams and/or trains and/or subways and/or light rail, etc.

### Multi-Layer Materials for Component Such as Vehicle Trim

According to an exemplary embodiment as indicated schematically in the FIGURES, an exemplary embodiment provides a composite structure for component such as vehicle trim, comprising:

A structural substrate; a cover layer; and a cover/base layer between the structural substrate and the cover layer; the cover layer is formed by injection molding, and a first layer/membrane is included between the cover/base layer and the cover layer.

According to an exemplary embodiment as indicated schematically in the FIGURES, an exemplary embodiment also provides a composite structure for component such as vehicle trim, comprising: A structural substrate; a cover layer; and a cover/base layer between the structural substrate and the cover layer; the cover layer is formed by foam injection molding.

The multi-layer material for component such as vehicle trim provided by an exemplary embodiment employs a lightweight frame and rationally combines a cover/base layer and a cover layer. While meeting the requirements for providing for reduction of weight of components, it also provides a soft-touch feel, enhancing the user experience, and is applicable to a wide range of scenarios. According to an exemplary embodiment, it can be used as component such as vehicle trim for dashboards, door panel inserts, seat back panels, steering wheel covers, and passenger dashboard armrest covers.

According to an exemplary embodiment, an exemplary embodiment also provides a component such as vehicle trim comprising the composite structure of an exemplary embodiment, and a vehicle comprising the component such as vehicle trim of an exemplary embodiment.

### Lightweight Frame

With energy conservation and environmental protection becoming increasingly topics, providing for reduction of weight of components is being widely applied to the field of general-purpose vehicles, improving handling while also achieving excellent fuel economy. A vehicle fuel consumption primarily depends on the engine displacement and total vehicle weight. While maintaining or even optimizing the overall quality, performance, and cost of the vehicle, reducing the weight can increase output power, reduce noise, improve handling and reliability, increase speed, reduce fuel consumption, reduce emissions, and enhance safety. Due to environmental protection and energy conservation needs, providing for reduction of weight of components of vehicles has become a development trend.

According to an exemplary embodiment, the structural substrate of an exemplary embodiment comprises hemp fiberboard, foamed hemp fiberboard, foamed glass fiberboard, polypropylene, polyimide, polycarbonate, or a combination. According to an exemplary embodiment, the thickness of the structural substrate is about 1.5 mm to 3 mm. According to an exemplary embodiment, the flexural modulus of the structural substrate is about 1800 MPa or higher. According to an exemplary embodiment, the density of the structural substrate is about 0.85 g/cm\hat{ }3 or lower. According to an exemplary embodiment, the structural substrate of an exemplary embodiment comprises hemp fiberboard. According to an exemplary embodiment, a second layer/membrane is included between the structural substrate and the cover/base layer. According to an exemplary embodiment, the second layer/membrane included between the structural substrate and the cover/base layer comprises polyethylene. According to an exemplary embodiment, the layer/membrane existing between the structural substrate and the cover/base layer is referred to as the second layer/membrane.

### Hemp Fiberboard

Hemp fiberboard is a type of high-strength, environmentally friendly material made primarily from natural hemp fibers through high-temperature and high-pressure processing. It comprises a combination of structural fibers and thermoplastic resin. The structural fibers can include natural fibers (such as hemp, wood, flax, kenaf, and sisal) or synthetic fibers (such as glass fiber, carbon fiber, and polymer fibers). According to an exemplary embodiment, hemp fiberboard can be a composite material of natural hemp fibers and approximately 40 percent-50 percent polypropylene. During heating, the polypropylene melts, causing the hemp fibers to bond together, forming a low-density, high-strength board or a three-dimensional structural material.

Hemp fiber is a natural plant fiber that contains no harmful substances and poses no harm to the human body. According to an exemplary embodiment, the product such as a component comprising the composite structure process of hemp fiberboard does not require the use of any harmful chemicals, thus avoiding pollution. Compared to chemical materials, the source is more environmentally friendly, and it is a renewable and biodegradable material. Hemp fiberboard also possesses excellent sound insulation, heat insulation, and fire resistance properties.

As indicated schematically in the FIGURES, an exemplary embodiment utilizes the lightweight characteristics of hemp fiberboard as a skeleton material, further enhancing the environmental advantages while retaining all the superior performance properties. Foamed hemp fiberboard can also be used as a structural substrate material in an exemplary embodiment.

### Fiberglass Board

Fiberglass board is a material synthesized from glass fiber and high-heat-resistant composite materials, possessing high mechanical properties, good heat and moisture resistance, and good processability. According to an exemplary embodiment, foamed fiberglass board can be used as a lightweight structural support material.

### Polypropylene (PP)

Polypropylene is a high-performance thermoplastic synthetic resin. It is a colorless, semi-transparent, lightweight, general-purpose thermoplastic plastic with chemical resistance, heat resistance, electrical insulation, high mechanical strength, and good wear-resistant processing properties.

Polypropylene tends to provide poor impact resistance at low temperatures, inadequate weather resistance, poor surface finish, and a gap between the electrical, magnetic, optical, thermal, and combustion functionalities and practical needs. According to an exemplary embodiment, polypropylene is modified. Through copolymerization modification, crosslinking modification, grafting modification, and the addition of nucleating agents, the polymer components and macromolecular structure or crystal configuration of polypropylene are altered, thereby improving the mechanical properties, heat resistance, aging resistance, and other properties, enhancing the overall performance, and expanding the application areas.

According to an exemplary embodiment, polypropylene containing a foaming agent and/or modified polypropylene are subjected to a foaming injection molding process to obtain the structural substrate of an exemplary embodiment.

### Polyimide (PI)

Polyimides are a class of polymers containing an imide ring (—CO—NR—CO—) in the main chain. Based on the chemical structure of the repeating units, polyimides can be classified into three types: aliphatic, semi-aromatic, and aromatic polyimides. Based on interchain interactions, such items/materials can be classified into cross-linked and non-cross-linked types. Polyimides are non-toxic, can withstand extremely low temperatures, possess excellent mechanical properties, a low coefficient of thermal expansion, high radiation resistance, and exhibit a variety of properties including thermoplasticity and thermosetting.

### Polycarbonate (PC)

Polycarbonate (also known as PC plastic) is a high molecular polymer containing carbonate groups in the molecular chain. Based on the structure of the ester groups, it can be classified into various types such as aliphatic, aromatic, and aliphatic-aromatic. Polycarbonate possesses high strength and elastic modulus, high impact strength, high fatigue resistance, a wide operating temperature range, and is easy to process and mold.

According to an exemplary embodiment, the surface of the structural substrate may be further laminated with a polyethylene (PE) film. According to an exemplary embodiment, the polyethylene film is located between the structural substrate and the flexible layer. According to an exemplary embodiment, the structural substrate with the PE film is heated to melt the PE film and laminate it with the structural substrate.

### Soft Layer

According to an exemplary embodiment, the cover/base layer is the material layer in the composite structure of an exemplary embodiment that primarily provides a soft touch. According to an exemplary embodiment, the thickness of the cover/base layer is approximately 0.5 mm to 3 mm. According to an exemplary embodiment, the Shore hardness C of the cover/base layer is approximately 30 to 60 degrees.

According to an exemplary embodiment, a first layer/membrane is included between the cover/base layer and the cover layer, the cover/base layer and the first layer/membrane existing in a composite form. According to an exemplary embodiment, the first layer/membrane is compatible with the skin injection molding material. According to an exemplary embodiment, the first layer/membrane material includes TPU, TPEE, or a combination. According to an exemplary embodiment, the first layer/membrane material includes TPU. In another preferred embodiment, the first layer/membrane material includes TPEE. According to an exemplary embodiment, the layer/membrane located between the cover/base layer and the cover layer is referred to as the first layer/membrane. The use of the layer/membrane prevents the injection molding material from penetrating into the cover/base layer, thereby preventing the cover/base layer from failing to provide the desired soft touch due to changes in the properties caused by the penetration of the injection molding material. According to an exemplary embodiment, the cover/base layer may not include the first layer/membrane.

According to an exemplary embodiment, the flexible layer comprises polyethylene terephthalate (PET) fiber nonwoven fabric, three-dimensional mesh fabric, sponge, thermoplastic polyester elastomer, an intermediate foam layer formed by foaming thermoplastic polyester elastomer, or a combination. According to an exemplary embodiment, the flexible layer comprises polyethylene terephthalate (PET) fiber nonwoven fabric. According to an exemplary embodiment, the flexible layer comprises a three-dimensional mesh fabric. According to an exemplary embodiment, the flexible layer comprises sponge. According to an exemplary embodiment, the flexible layer comprises a thermoplastic polyester elastomer. According to an exemplary embodiment, the flexible layer comprises an intermediate foam layer formed by foaming thermoplastic polyester elastomer.

### Polyethylene Terephthalate Fiber Nonwoven Fabric

Nonwoven fabric (also known as non-woven cloth) is composed of oriented or randomly arranged fibers.

Polyester is a type of synthetic fiber, made from polyethylene terephthalate (PET) through spinning and post-treatment. The polyester molecule consists of short aliphatic hydrocarbon chains, ester groups, benzene rings, and terminal alcohol hydroxyl groups. Due to the aliphatic hydrocarbon chains, it possesses flexibility. Polyester also exhibits the high strength, good elasticity, heat resistance, thermoplasticity, abrasion resistance, light resistance, and corrosion resistance. Its moisture absorption is poor; it dries very easily after washing and does not deform.

According to an exemplary embodiment, the cover/base layer of an exemplary embodiment comprises polyethylene terephthalate (PET) fiber nonwoven fabric. As indicated schematically in the FIGURES, an exemplary embodiment uses PET fiber nonwoven fabric as the cover/base layer to provide a soft touch while retaining the various advantageous properties.

### Three-Dimensional (3D) Mesh Fabric

Three-dimensional (3D) mesh fabric is a pure woven material with good elasticity and support. It has excellent resilience, moisture permeability, good mechanical properties and chemical stability, and can provide cushioning protection. It can be used in Three-dimensional (3D) mattresses, Three-dimensional (3D) pillows, Three-dimensional (3D) car seat cushions, etc. that is in line with the international development concept of saving resources and protecting the environment.

According to an exemplary embodiment, the cover/base layer of an exemplary embodiment comprises a three-dimensional mesh fabric. As indicated schematically in the FIGURES, an exemplary embodiment can use a three-dimensional mesh fabric as the cover/base layer, providing a soft touch while retaining the various advantageous properties.

### Sponge

According to an exemplary embodiment as indicated schematically in the FIGURES, sponge refers to artificial sponge (also known as synthetic sponge or chemical sponge) that is the material conventionally understood by those skilled in the art. It is typically synthesized artificially using raw materials such as polyester and is a type of polyurethane foam.

As indicated schematically in the FIGURES, an exemplary embodiment can use a sponge as a cover/base layer to provide a soft touch. According to an exemplary embodiment, the cover/base layer of an exemplary embodiment includes a sponge.

### Thermoplastic Polyester Elastomer (TPEE)

Thermoplastic polyester elastomer (TPEE) (also known as polyester rubber) is a type of linear block copolymer containing PBT (polybutylene terephthalate) hard polyester segments and aliphatic polyester or polyether soft segments. TPEE combines the excellent elasticity of rubber with the easy processability of thermoplastics. Its hardness is adjustable, and it possesses properties such as resistance to flexural fatigue, impact resistance, chemical resistance, weather resistance, and good adhesion.

As indicated schematically in the FIGURES, an exemplary embodiment utilizes treated TPEE as a cover/base layer, providing a soft touch while retaining the various advantageous properties. According to an exemplary embodiment, the treated TPEE comprises TPEE containing a foaming agent processed by a foaming injection molding process. According to an exemplary embodiment, the cover/base layer of an exemplary embodiment comprises an intermediate foamed layer formed from the foamed TPEE.

### Skin/Cover

According to an exemplary embodiment as indicated schematically in the FIGURES, the skin refers to the outermost structure of the composite structure provided by an exemplary embodiment that is in contact with the user. According to an exemplary embodiment, the skin of an exemplary embodiment may possess a certain soft texture, further enhancing the soft tactile feel provided by the cover/base layer. According to an exemplary embodiment, the skin thickness is approximately 0.4 mm to 1.2 mm. According to an exemplary embodiment, the skin thickness is approximately 1 mm. According to an exemplary embodiment, the skin thickness is approximately 0.5 mm. According to an exemplary embodiment, the Shore A hardness of the skin is approximately 40 to 80 degrees. According to an exemplary embodiment, the density of the skin is approximately 1 g/cm\hat{ }3 to 1.3 g/cm\hat{ }3.

According to an exemplary embodiment, the cover layer comprises a thermoplastic polyester elastomer or a self-skinned surface formed therefrom after foaming, a thermoplastic vulcanized rubber, polyurethane, or a combination. According to an exemplary embodiment, the cover layer comprises a thermoplastic polyester elastomer or a self-skinned surface formed therefrom after foaming. According to an exemplary embodiment, the cover layer comprises a thermoplastic polyester elastomer. According to an exemplary embodiment, the cover layer comprises a self-skinned surface formed therefrom after foaming a thermoplastic polyester elastomer. According to an exemplary embodiment, the thermoplastic polyester elastomer comprises a polystyrene elastomer. The cover layer of an exemplary embodiment may further comprise a cover layer having a specific pattern, recesses, or protrusions.

The Surface Skin Formed after the Thermoplastic Polyester Elastomer is Foamed

According to an exemplary embodiment, the cover layer of an exemplary embodiment comprises a self-skinning surface formed after foaming of a thermoplastic polyester elastomer.

Thermoplastic polyester elastomer undergoes a foaming process under the action of a foaming agent, resulting in a three-layer structure as shown in FIG. 35: inner and outer self-skins (surface self-skin and lower self-skin) and an intermediate foamed layer. The cover layer described in an exemplary embodiment includes a surface self-skin formed after the foamed injection molding material is completed; it is located on the outermost side of the composite structure and can be used for contact with the user. According to an exemplary embodiment, the cover layer described in an exemplary embodiment includes a surface self-skin formed after TPEE foaming injection molding.

### Thermoplastic Vulcanizate (TPV)

Thermoplastic vulcanizate (also known as thermoplastic dynamic vulcanizate) uses the term dynamic to describe the product such as a component comprising the composite structure process-dynamic vulcanization. Such a process involves vulcanizing the rubber during the melt-blending of the rubber and thermoplastic. As the rubber vulcanizes, it continuously mixes with the thermoplastic phase, resulting in the vulcanized rubber existing as a dispersed phase within the continuous thermoplastic phase. Thermoplastic vulcanizate possesses characteristics such as high elasticity, high strength, environmental friendliness, safety, non-toxicity, high temperature resistance, solvent resistance, impact resistance, and a soft touch.

Thermoplastic vulcanizate (TPV) elastomers comprise blends of dynamically cured elastomers and thermoplastic resins; the elastomers are dispersed in the thermoplastic resin phase as fine elastomer particles. TPVs advantageously exhibit many of the properties of thermosetting elastomers and are also processable like thermoplastics. Elastomers commonly used to form TPVs are ethylene, α-olefin, and diene rubber copolymers, such as ethylene, propylene, and diene monomer (EPDM) rubbers.

### Preparation Method of an Exemplary Embodiment

### First Method

As indicated schematically in the FIGURES, an exemplary embodiment provides a method for preparing composite structures (also referred to according to an exemplary embodiment as the first method), comprising: Provide structural substrate materials, cover layer materials, cover/base layer materials, and first layer/membrane materials; Soften the structural substrate material. The first layer/membrane material is combined with the cover/base layer material to obtain a cover/base layer with a layer/membrane.

The pre-treated/heated softened structural substrate material is molded with the cover/base layer with the layer/membrane to obtain a structural substrate with a cover/base layer.

A cover layer material is injection molded onto the surface of the layer/membrane material of the structural substrate with a cover/base layer to obtain the composite structure. Softening the structural substrate material can be performed in any manner conventionally used by those skilled in the art, including but not limited to softening the structural substrate material by heating.

According to an exemplary embodiment, the first method for preparing the composite structure of an exemplary embodiment further includes: pre-placing a plastic structural component in the lower mold of a hot press before molding the pre-treated/heated softened structural substrate material with the cover/base layer having a layer/membrane, and heating the surface of the plastic structural component to melt. The composite structure of an exemplary embodiment can be combined with different structural components to obtain product such as a component applicable to different scenarios.

According to an exemplary embodiment, the structural substrate material includes hemp fiberboard, foamed hemp fiberboard, foamed glass fiberboard, polypropylene, polyimide, polycarbonate, or combinations. According to an exemplary embodiment, the structural substrate material includes hemp fiberboard. According to an exemplary embodiment, the structural substrate surface has a second layer/membrane. According to an exemplary embodiment, the structural substrate and the second layer/membrane exist in a composite form. According to an exemplary embodiment, the structural substrate surface has a polyethylene (PE) layer/membrane that melts and composites with the structural substrate upon heating. According to an exemplary embodiment, the polyethylene layer/membrane on the surface of the structural substrate is located between the structural substrate and the cover/base layer. According to an exemplary embodiment, the surface of the hemp fiberboard has a polyethylene layer/membrane that is located between the hemp fiberboard and the cover/base layer.

According to an exemplary embodiment, the structural substrate material is pre-treated/heated softened by heating. According to an exemplary embodiment, the heating temperature is about 200 deg C.-250 deg C. According to an exemplary embodiment, the heating temperature is about 220 deg C.-230 deg C. According to an exemplary embodiment, the heating temperature is about 220 deg C.

According to an exemplary embodiment, the structural substrate material is pre-treated/heated softened by heating. According to an exemplary embodiment, the heating time is approximately 2 to 7 minutes. According to an exemplary embodiment, the structural substrate material is pre-treated/heated softened by heating for approximately 5 minutes.

According to an exemplary embodiment, the cover/base layer material comprises polyethylene terephthalate (PET) fiber nonwoven fabric. According to an exemplary embodiment, the surface of the cover/base layer has a first layer/membrane. According to an exemplary embodiment, the first layer/membrane on the surface of the cover/base layer is located between the cover/base layer and the cover layer. The first layer/membrane of an exemplary embodiment needs to be compatible with the injection molding material it contacts. According to an exemplary embodiment, the first layer/membrane comprises polypropylene, polyethylene, polyethylene terephthalate, thermoplastic polyurethane elastomer, thermoplastic polyester elastomer, or a combination. According to an exemplary embodiment, the first layer/membrane comprises a thermoplastic polyurethane elastomer or a thermoplastic polyester elastomer, or a combination. According to an exemplary embodiment, the first layer/membrane comprises a thermoplastic polyurethane elastomer. In another more preferred embodiment, the first layer/membrane comprises a thermoplastic polyester elastomer. According to an exemplary embodiment, the first layer/membrane located between the cover/base layer and the cover layer prevents the injection molding material from penetrating into the cover/base layer, thereby preventing the cover/base layer from failing to provide the desired soft touch due to changes in the properties caused by the penetration of the injection molding material.

According to an exemplary embodiment, the step of laminating the first film material with the flexible layer material includes hot-melt lamination or film lamination. According to an exemplary embodiment, the step of laminating the first film material with the flexible layer material is hot-melt lamination that is accomplished by heating the first film material and the flexible layer material to a temperature approximately 5 deg C. to 40 deg C. above the melting point of the first film material. According to an exemplary embodiment, the step of laminating the first film material with the flexible layer material is hot-melt lamination; the flexible layer material comprises PET nonwoven fabric, the first film material comprises TPU, and the PET nonwoven fabric and TPU are heated to approximately 140 deg C.

According to an exemplary embodiment, the step of laminating the first film material with the cover/base layer material is a film lamination process that is accomplished by adding an adhesive film between the first film material and the cover/base layer material and heating it to a temperature above the melting point of the adhesive film but below the melting point of the film material. According to an exemplary embodiment, the adhesive film used in the film lamination of the first film material and the cover/base layer material includes a polyethylene adhesive film, a polyamide adhesive film, a polyester adhesive film, or a combination. According to an exemplary embodiment, the adhesive film is a polyamide adhesive film. According to an exemplary embodiment, the step of laminating the first film material with the cover/base layer material is a film lamination process; the cover/base layer material includes PET nonwoven fabric, the film material includes TPU, and the PET nonwoven fabric, TPU, and adhesive film are heated to approximately 120 deg C.

According to an exemplary embodiment, the cover layer injection molding material includes thermoplastic polyester elastomer, thermoplastic vulcanized rubber, and polyurethane. According to an exemplary embodiment, the cover layer injection molding material includes thermoplastic polyester elastomer.

### Second Method

According to an exemplary embodiment, an exemplary embodiment provides a method for preparing a composite structure (which may also be referred to according to an exemplary embodiment as the second method), comprising: A structural substrate material and a cover layer material are provided; the cover layer material contains a foaming agent; Soften the structural substrate material. The pre-treated/heated softened structural substrate material is molded to obtain a structural substrate.

A cover layer material is injection molded onto the surface of the structural substrate and then foamed to obtain the composite structure.

According to an exemplary embodiment, softening the structural substrate material can be done in any manner commonly used by those skilled in the art, including but not limited to softening the structural substrate material by heating.

According to an exemplary embodiment, a foaming agent is mixed with a cover layer material in a certain proportion to obtain a cover layer material containing the foaming agent. The foaming agent used in an exemplary embodiment can be a foaming agent conventionally used by those skilled in the art, such as organic chemical foaming agents, including but not limited to aliphatic hydrocarbons (e.g., butane, pentane, hexane, octane, etc.), chlorinated hydrocarbons (e.g., dichloroethane), chlorofluorocarbons (e.g., Freon), isocyanate compounds, azo compounds, hydrazine derivatives, urea-amino compounds, azide compounds, nitroso compounds, triazole compounds, etc. According to an exemplary embodiment, the foaming agent includes a foaming masterbatch of foamed microspheres. Conventionally used foaming agents also include inorganic chemical foaming agents, including but not limited to carbon dioxide, nitrogen, combinations of sodium bicarbonate and acid, combinations of hydrogen peroxide and yeast, combinations of zinc and acid, bicarbonates, carbonates, hydrides, etc. According to an exemplary embodiment, the foaming agent includes a combination of sodium bicarbonate and acid. In a specific embodiment, the foaming agent includes a combination of sodium bicarbonate and sodium citrate. The foaming process used in an exemplary embodiment can be a method conventionally used by those skilled in the art, including but not limited to physical foaming, thermal decomposition of the foaming agent to generate gas foaming, or chemical foaming by reacting the components of the foaming agent to generate gas foaming. According to an exemplary embodiment, the cover layer material containing the foaming agent comprises a cover layer material containing about 2 percent to 5 percent by weight of the foaming agent. According to an exemplary embodiment, the cover layer material containing the foaming agent comprises a TPEE containing about 2 percent to 5 percent by weight of the foaming agent. According to an exemplary embodiment, the cover layer material containing the foaming agent comprises a TPEE containing about 2 percent to 5 percent by weight of the foaming masterbatch. According to an exemplary embodiment, the cover layer material containing the foaming agent comprises a TPEE containing about 3 percent by weight of the foaming masterbatch.

According to an exemplary embodiment, the structural substrate material includes hemp fiberboard, polypropylene, polyimide, polycarbonate, or combinations. According to an exemplary embodiment, the structural substrate material includes hemp fiberboard.

According to an exemplary embodiment, the structural substrate material is pre-treated/heated softened by heating. According to an exemplary embodiment, the heating temperature is about 200 deg C.-250 deg C. According to an exemplary embodiment, the heating temperature is about 220 deg C.-230 deg C. According to an exemplary embodiment, the heating temperature is about 220 deg C.

According to an exemplary embodiment, the structural substrate material is pre-treated/heated softened by heating. According to an exemplary embodiment, the heating time is approximately 2 to 7 minutes. According to an exemplary embodiment, the heating time is approximately 5 minutes.

According to an exemplary embodiment, the cover layer material containing the foaming agent comprises a thermoplastic polyester elastomer containing the foaming agent.

According to an exemplary embodiment, the composite structure may not include a first layer/membrane located between the cover/base layer and the cover layer. According to an exemplary embodiment, the composite structure optionally includes a second layer/membrane located between the structural substrate and the cover/base layer. According to an exemplary embodiment, the second layer/membrane comprises polypropylene, polyethylene, polyethylene terephthalate, thermoplastic polyurethane elastomer, thermoplastic polyester elastomer, or a combination. According to an exemplary embodiment, the second layer/membrane comprises polypropylene, polyethylene, or a combination. According to an exemplary embodiment, the second layer/membrane comprises polyethylene. According to an exemplary embodiment, the structural substrate and the second layer/membrane exist in a composite form.

According to an exemplary embodiment, an exemplary embodiment provides a component such as vehicle trim comprising the composite structure of an exemplary embodiment and/or a composite structure prepared by the first method and/or the second method provided by an exemplary embodiment. According to an exemplary embodiment, an exemplary embodiment provides a component such as vehicle trim comprising the composite structure of an exemplary embodiment. According to an exemplary embodiment, an exemplary embodiment provides a component such as vehicle trim comprising the composite structure prepared by the first method and/or the second method provided by an exemplary embodiment. According to an exemplary embodiment, the component such as vehicle trim comprising the composite structure of an exemplary embodiment and/or a composite structure prepared by the first method and/or the second method provided by an exemplary embodiment includes: a dashboard, a door panel trim, a seat back panel, a steering wheel cover, and a passenger dashboard armrest cover.

### Beneficial Effects

The multi-layer material provided by an exemplary embodiment can be used in component such as vehicle trim, such as dashboards, door panel trim, seat back panels, steering wheel covers, and passenger dashboard armrest covers, etc., and provides a soft touch, bringing users an enhanced tactile experience and a better user experience, while also being lightweight and environmentally friendly.

According to an exemplary embodiment, an exemplary embodiment also provides a method for preparing the aforementioned lightweight composite structure. A two-color compression molding process allows for the molding of a cover/base layer and injection molding of the skin onto a lightweight framework, eliminating the need for overcoating or foaming, thus avoiding the use of adhesives, making it more environmentally friendly, improving the process, reducing energy consumption, and thereby increasing product such as a component comprising the composite structure capacity. The method of an exemplary embodiment can employ compression molding and foam injection molding processes to obtain the lightweight, soft-textured composite structure of an exemplary embodiment. It is simple to operate, economical, and conducive to industrial product such as a component comprising the composite structure.

### EXAMPLES

As indicated schematically in the FIGURES, an exemplary embodiment will now be described in further detail with reference to specific embodiments.

### Example 1: Multilayer Material of an Exemplary Embodiment and the Preparation

The composite structure of an exemplary embodiment was prepared by using hemp fiberboard (purchased from Jiangyin Yanli Automotive Interior Parts Co., Ltd.) as the structural substrate material, PET nonwoven fabric as the cover/base layer, and TPEE (purchased from Hefei Huitong New Materials Co., Ltd.) as the skin injection molding material, and through the exemplary steps:
1. A PE film with a density of approximately 50 g/cm\hat{ }3-100 g/cm\hat{ }3 is placed on the surface of a hemp fiberboard. The board is then heated by a hot plate and pressed into shape by a flat plate to obtain a hemp fiberboard with a PE film layer;
2. Place the hemp fiberboard with a PE film on the surface in an oven and heat it at a temperature of about 220 deg C. for about 5 minutes to soften the hemp fiberboard and melt the PE film on the surface to bond with the hemp fiberboard;
3. The TPU film is thermally melt-bonded with the soft PET nonwoven fabric at a bonding temperature of about 140 deg C. to obtain PET nonwoven fabric with TPU film;
4. Place the plastic structural parts in the lower mold of the hot press mold and heat them to melt the surface of the plastic structural parts;
5. Place the pre-treated/heated softened hemp fiber board in the lower mold of the hot press mold, and place the PET nonwoven fabric with TPU film on the pre-treated/heated softened hemp fiber board. The TPU film is located on the side of the PET nonwoven fabric away from the structural substrate; perform molding to obtain a structural substrate with a cover/base layer;
6. Place the structural substrate with the cover/base layer into the injection mold, and inject TPEE onto the surface of the skeleton.

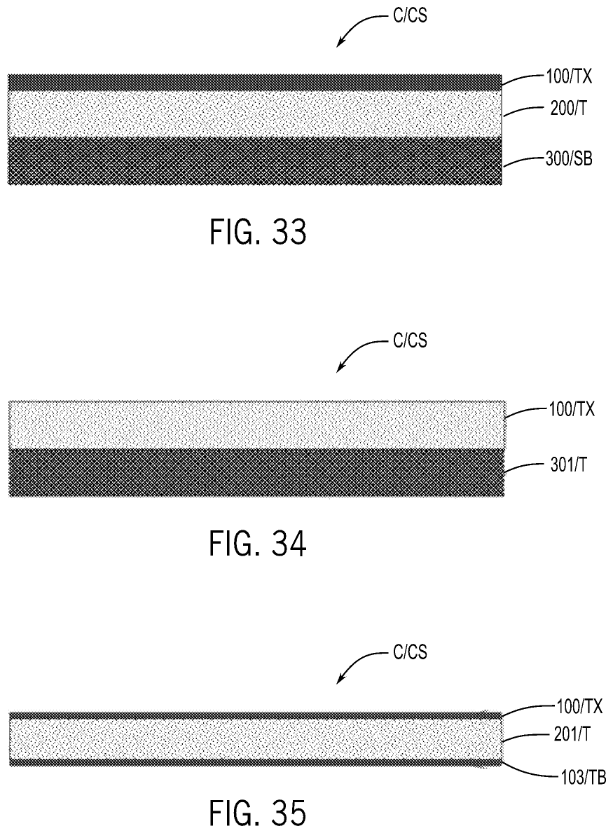

The structure of the composite structure product such as a component 1 obtained by the method is shown in FIG. 33. As indicated schematically, cover 100 for the composite structure is the injection-molded cover layer formed by injection molding of TPEE material, cover/base layer 200 for the composite structure is the cover/base layer formed by PET nonwoven fabric material, and substrate/base 300 for the composite structure is the structural substrate formed by hemp fiberboard material.

### Example 2: Multilayer Material of an Exemplary Embodiment and the Preparation

The composite structure of an exemplary embodiment is prepared by using hemp fiberboard as a structural substrate material and TPEE containing a foaming agent as an injection molding material, and through the exemplary steps: 1. Place the hemp fiberboard in an oven and heat it to approximately 220 deg C. for about 5 minutes to soften the hemp fiberboard; 2. Place the pre-treated/heated softened hemp fiberboard into the injection mold and perform compression molding. Inject the structure from the back and the perimeter and seal the edges to obtain a structural substrate; 3. Place the structural substrate in the injection mold, keep the mold slightly open, and inject TPEE containing about 3 percent by weight of foaming masterbatch onto the surface of the skeleton.

In particular, when injection molding TPEE with foaming agent onto the skeleton surface, keeping the mold slightly open is to leave enough space for the TPEE to foam.

The structure of the composite structure product such as a component 2 obtained by the method is shown in FIGS. 2 and 3. In FIG. 34, composite structure 10 is a three-layer structure formed after the foam injection molding of the TPEE skin material with foaming agent, and 301 is a structural substrate formed by hemp fiberboard. In FIG. 35, cover 101 for the composite structure is a surface self-skin formed after foam injection molding that serves as the injection skin; 201 is an intermediate foam layer formed after foam injection molding that serves as the cover/base layer; and 103 is a lower self-skin formed after foam injection molding that is bonded to the structural substrate.

### Example 3 Hardness Test

According to the preparation method of Example 1, the cover/base layer was replaced with sponge (purchased from Shanghai Jinzhida Composite Materials Co., Ltd.) to prepare the composite structure product such as a component 3 of an exemplary embodiment.

Control product such as a component were prepared using compression molding (CHyM) process, skin injection molding, or two-color injection molding.

The specific preparation steps are as follows:
1. Fiberboard (purchased from Jiangyin Yanli Automotive Interior Parts Co., Ltd.) is used to prepare compression molded parts by compression molding.
2. A cover layer is formed on the surface of the compression-molded part by injection molding TPEE material (purchased from Hefei Huitong New Material Co., Ltd.) to obtain the control product such as a component.

The hardness of the product of an exemplary embodiment such as a component/product (Products 1, 2 and 3) was determined and characterized using the standardized test procedures of ISO 7619-1:2004 or ASTM D2240 according to the Shore method. See TABLE X.

TABLE X

| | | | | Comparative |
|---|---|---|---|---|
| Item | Product 1 | Product 2 | Product 3 | Product |
| Shore C | 50-60 | 40-60 | 30-50 | ≥60 |
| Hardness | | | | |

As shown in TABLE X, the Shore C hardness of the product such as a component of an exemplary embodiment is all below 60. Compared with the control product such as a component, the product such as a component each have a lower Shore C hardness, thus providing a softer touch and a significantly improved tactile experience for the user.

Those skilled in the art will recognize that many modifications and variations can be made to an exemplary embodiment without departing from the spirit and scope. The specific embodiments described according to an exemplary embodiment are provided by way of example only and are not intended to limit the scope in any way. The true scope and spirit of an exemplary embodiment are shown in the appended claims, and the description and embodiments are according to an exemplary embodiment.

### Exemplary Embodiments—D

With the rapid development of the transportation sector, vehicles such as automobiles have become means of transportation, and the interiors have become one of the biggest selling points. Such interiors can include dashboards, door panel trim, seat backs, steering wheel covers, and passenger-side dashboard armrest covers. As consumers become more brand-conscious and take into account the functionality of interiors, development has shifted towards a human-centered user experience. While meeting the requirements for interior shape and function, efforts are being made to satisfy consumers' functional needs and psychological desires, with energy conservation and environmental protection gradually becoming the themes of technological development.

According to an exemplary embodiment, providing for reduction of weight of components of materials has become a trend in the automotive industry. Using more aluminum alloys, magnesium alloys, and engineering plastics without affecting the body strength helps reduce the vehicle weight. At the same time, providing for reduction of weight of components of trim is also an aspect, resulting in better fuel economy.

To enhance tactile feel and provide a better user experience, vehicle interior components, such as dashboard, door panel trim, seat back panels, steering wheel cover, and passenger dashboard armrest cover, typically employ a multi-layered structure consisting of a bottom injection-molded skeleton, a middle cover/base layer, and a surface covering.

Currently, injection-molded skins typically employ polyurethane (PU) foaming or overmolding processes to bond with a polypropylene (PP) skeleton or an ABS engineering plastic (PC/ABS) injection-molded skeleton. Such an item/material involves at least three steps: skeleton injection molding, skin injection molding, and PU foaming or overmolding. The process is quite complex, requiring a large amount of adhesive to bond the skin to the skeleton during finished product such as a component preparation. According to an exemplary embodiment, ABS engineering plastics are relatively heavy, have a low heat distortion temperature, poor weather resistance, and are prone to degradation under ultraviolet light. According to an exemplary embodiment, such items/materials do not align with the concepts of energy conservation and environmental protection.

CN106393890A discloses an ultra-soft, environmentally friendly thermoplastic polyolefin (TPO) automotive interior material that improves the softness of the interior material, increases the comfort of the product such as a component, and uses a soft water-based polyurethane paint for surface coating, combined with a soft sponge.

As indicated schematically in the FIGURES, an exemplary embodiment relates to a multi-layer material for component such as vehicle trim components and a manufacturing method therefor. The multi-layer material of an exemplary embodiment can be used for component such as vehicle trim components, such as dashboards, door panel inserts, seat back panels, steering wheel covers and center console armrest covers that provides soft touch while achieving the advantage of light weight, thus bringing the improved touch feeling and better use experience to users, allowing for simple manufacturing process, and facilitating industrial product such as a component comprising the composite structure.

### Exemplary Embodiments—E

As indicated schematically, the injection molded skin is bonded to the substrate through PU foaming or coating process, using PP substrate or PC/ABS injection molding substrate, and there are at least three process steps: substrate injection molding, skin injection molding, PU foaming or coating. There is difficulty achieving the concept of lightweight and natural environmental protection. As indicated schematically in the FIGURES, an exemplary embodiment provides a multi-layer structure product such as a component comprising a lightweight natural environmentally friendly substrate and an injection-molded skin, and a process solution to realize such a multi-layer product such as a component that can be hard or soft to the touch.

As indicated schematically, the composite structure/component may comprise: Lightweight substrate and injection molded skin, with the concept of lightweight and natural environmental protection, the product such as a component has a leather touch; Lightweight substrate and foam or non-woven fabric and injection molded skin, with the concept of lightweight and natural environmental protection, the product such as a component can also have a soft touch.

As indicated schematically: The one-step method is injected into the skin on the substrate that does not need to be wrapped or foamed, and the process is simplified to avoid the use of glue. The two-color molding injection molding process allows for one-step molding of the substrate and skin injection, making the process more simplified.

As indicated schematically, the composite structure/component may comprise: A diaphragm/layer between the cover/base layer and the injection molded skin that prevents the injection molded material from penetrating into the cover/base layer.

The diaphragm/layer material is TPU, TPEE and other polar materials that need to be compatible with the skin injection molding material TPEE. The diaphragm/layer and cover/base layer need to be reviewed in advance, and the composite method is hot melt composite or adhesive film composite. As indicated schematically, the composite structure/component may be provided with TPU film hot melt composite as an example: the composite temperature is 140 deg C. that is slightly higher than the melting point of TPU, and no additional adhesive materials, such as adhesive film, are required. Taking the film composite of TPU film as an example, a layer of adhesive film is required between the TPU film and the cover/base layer, and the composite temperature is 120 deg C. that is slightly higher than the melting point of the film and slightly lower than the melting point of TPU.

As indicated schematically, the composite structure/component may comprise: A diaphragm/layer between the cover/base layer and the injection molded skin that prevents the injection molded material from penetrating into the cover/base layer.

The diaphragm/layer material is TPU, TPEE and other polar materials that need to be compatible with the skin injection molding material TPEE. The diaphragm/layer and cover/base layer need to be reviewed in advance, and the composite method is hot melt composite or adhesive film composite. As indicated schematically, the composite structure/component may be provided with TPU film hot melt composite as an example: the composite temperature is 140 deg C. that is slightly higher than the melting point of TPU, and no additional adhesive materials, such as adhesive film, are required. Taking the film composite of TPU film as an example, a layer of adhesive film is required between the TPU film and the cover/base layer, and the composite temperature is 120 deg C. that is slightly higher than the melting point of the film and slightly lower than the melting point of TPU.

The combination of lightweight natural materials and injection molded skin enhances product such as a component performance, competitiveness, etc.

As indicated schematically in the FIGURES, an exemplary embodiment relates to a three-layer structure of a product such as a component comprising a lightweight substrate at the bottom, a cover/base layer in the middle, and an injection molded skin on the surface 10, involving the field of automobile interior parts.

Automobile interior parts, such as the dashboard, door panel inserts and tops, and the sub-dashboard armrest covers, in order to improve the tactile feeling, will be made into a three-layer structure including the bottom injection molded substrate, the middle cover/base layer, and the surface layer covering the skin.

The intermediate cover/base layer of a three-layer structure product such as a component is a soft material with a layer of film on the surface, such as a layer of TPU film on the surface of foam or non-woven fabric that prevents the skin injection molding material from penetrating into the cover/base layer during the injection molding process, resulting in the loss of soft touch of the cover/base layer.

As indicated schematically, the composite structure/component may be provided with the lightweight substrate as hemp fiberboard, the cover/base layer as PET non-woven fabric with TPU film on the surface, and the surface injection molded skin as TPEE material.
1. The hemp fiber board with a layer of PE film on the surface is heated by the oven, the oven temperature is 230 deg C., and the heating time is 4 minutes, so that the hemp fiber board is pre-treated/heated softened and the PE film on the surface melts.
2. The plastic structural parts are pre-placed under the hot pressing mold, and the heating device heats the plastic structural parts to melt the surface.
3. Spread the heated hemp fiber board on the lower mold, and lay the non-woven fabric with TPU film on the hemp fiber board, in which the side with the TPU film is facing up, and the molded molding is made, and the product such as a component is a lightweight substrate with a cover/base layer.
4. Put the lightweight substrate into the injection mold and inject a layer of TPEE material on the surface of the substrate. The product such as a component made is the ginseng structure product such as a component described according to an exemplary embodiment.

As indicated schematically in the FIGURES, an exemplary embodiment relates to a product such as a component with a two-layer structure, comprising a lightweight substrate 30 at the bottom, and a layer of foam injection molding skin 10 on the surface; the surface foam injection molding skin is a three-layer structure, with a self-crust on the surface 11, a foam layer in the middle 12, and a self-crust on the lower layer 13, involving the field of automobile interior parts.

Automobile interior parts, such as the dashboard, door panel inserts and tops, and the sub-instrument panel armrest cover, in order to improve the tactile feeling, will be made into a three-layer structure including the bottom injection molded substrate, the middle cover/base layer, and the surface layer covering the skin that is different from the traditional soft touch product such as a components, an exemplary embodiment adopts hemp fiber board or micro-foam lightweight substrate, and the surface is foam injection molded skin.

As indicated schematically, the composite structure/component may comprise: Chemical blowing agent is added to the skin injection molding material TPEE, the skin is injected on the surface of the lightweight substrate, the mold is slightly opened, and the injection molding skin is foamed in the middle to form a three-layer structure with self-crust on both sides, of which the surface self-crust is used as the appearance surface, the middle foam layer provides a soft touch, and the bottom layer self-crust is bonded to the substrate.

As indicated schematically, the composite structure/component may be provided with the lightweight substrate as hemp fiberboard and the surface injection molded skin as TPEE material. 1. The hemp fiberboard is heated by the oven, the oven temperature is 230 deg C., and the heating time is 4 minutes to soften the hemp fiberboard; 2. The heated hemp fiberboard is put into the injection mold, closed and pressed into shape, and the back and periphery are injected into the structure and sealing edge to obtain a lightweight substrate; 3. Put the lightweight substrate into the injection mold, inject a layer of injection molding skin material with blowing agent on the surface, open the mold slightly, leave room for foaming, and get the double-layer structure of soft touch product such as a components.

To gain a more complete understanding of an exemplary embodiment, reference is now made to embodiments shown in more detail in the accompanying drawings and described by way of examples of an exemplary embodiment:
FIG. 33 indicates schematically an embodiment of the composite structure of an exemplary embodiment; cover 100 for the composite structure is an injection-molded cover layer formed by injection molding of cover layer material, cover/base layer 200 for the composite structure is a cover/base layer formed by cover/base layer material, and substrate/base 300 for the composite structure is a structural substrate formed by structural substrate material.

FIG. 34 indicates schematically another embodiment of the composite structure of an exemplary embodiment; composite structure 10 is a foamed injection-molded skin that is a three-layer structure layer formed after the cover layer material containing foaming agent is foamed and injection-molded, and 301 is a structural substrate formed by a structural substrate material.

FIG. 35 indicates schematically the composite structure 10 foamed injection-molded skin in the embodiment shown in FIG. 34; cover 101 for the composite structure is the surface self-skin formed after foaming injection molding, serving as the injection-molded cover layer; 201 is the intermediate foamed layer formed after foaming injection molding, serving as the cover/base layer; and 103 is the lower self-skin formed after foaming injection molding that is bonded to the structural substrate.

TABLE A
REFERENCE SYMBOL LIST

| REFERENCE | |
|---|---|
| SYMBOL | ELEMENT, PART OR COMPONENT |
| V | Vehicle |
| VI | Vehicle Interior |
| C | Component |
| CS | Composite Structure |
| DP | Door Panel |
| FC | Floor Console |
| GB | Receptacle/Storage (Glove Box, etc.) |
| IP | Instrument Panel/Assembly |
| AR | Armrest/armrest assembly |
| VN | Visor/Vanity (Panel/Flap) |
| NKF | Frunk |
| NKR | Trunk |
| OHC | Overhead Console |
| OHP | Overhead Panel |
| PL | Pillar |
| PN | Panel |
| | (e.g. trim panel, fiber panel, formed panel, etc.) |
| RB | Structure/feature |
| | (e.g. resin feature, structure, structural element, |
| | reinforcement, rib, etc.) |
| SB | Substrate |
| SBa SBb SBc | (e.g. structural substrate, base, base layer, |
| | structure, etc.) |
| SW | Steering Wheel/Assembly |
| SZ | Seat/Seat Assembly |
| T | Cover/cover base/layer |
| TB | Barrier layer |
| TN | Intermediate layer |
| TP | Coating (e.g. applied coating, film, etc.) |
| TX | Cover layer/Exterior Surface |
| WT | Liquid/liquid drops (e.g. water drops) |
| ZF | Force-applying tool/object |
| M | Module |
| MD | Device |
| | (e.g. mobile device, object, etc.) |
| MT | Tool |
| | (e.g. mold, injection mold, press, oven, heater, etc.) |
| OB | Object |
| | (e.g. mobile device, object, item, etc.) |
| 10 | Composite structure |
| CS | (e.g. comprising substrate, cover with base layer |
| | and cover layer, skin, etc.) |
| 100 | Cover/skin layer for base layer and cover |
| TX | (e.g. formed, molded, injection-molded layer, etc.) |
| 200 | base layer for cover |
| T | (e.g. base, resilient/soft layer, etc.) |
| 300 301 | Substrate/base |
| SB | (e.g. structural substrate, structure, lightweight |
| | skeleton/structure, etc.) |
| 101 | Cover/skin layer for base layer and cover |
| TX | (e.g. formed, molded, injection-molded layer, etc.) |
| 201 | base layer for cover |
| T | (e.g. base, resilient/soft layer, etc.) |
| 103 | Intermediate/barrier layer/membrane for cover |
| TB TN | (e.g. formed, molded, injection-molded layer, etc.) |

It is to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A component comprising:
a composite structure comprising a cover and a structural substrate;
wherein the cover comprises a base layer and a cover layer;
wherein the base layer of the cover is configured to provide a base for the cover;
wherein the cover layer of the cover is configured to provide an exterior surface for the composite structure;
wherein the cover layer of the cover comprises a cover layer material on the base layer of the cover;
wherein the cover layer material comprises an applied material and/or a formed material;
wherein the base layer of the cover comprises a base layer material.

2. The component of claim 1 wherein the composite structure comprises an interface between the structural substrate and the cover wherein the interface comprises an intermediate layer.

3. The component of claim 1 wherein the cover layer material comprises an applied material comprising a coating.

4. The component of claim 1 wherein the cover layer comprises a molded layer and/or an injection molded layer and/or a foam molded layer and/or a skin layer.

5. The component of claim 1 wherein the base layer comprises a molded layer.

6. The component of claim 1 wherein the base layer material comprises a polymer material and/or a molded material and/or an injection-molded material and/or a film and/or a polymer material and/or an elastomer and/or a thermoplastic elastomer and/or at least one of TPEE and/or TPU and/or TPV and/or TPE-S.

7. The component of claim 1 the cover layer comprises a molded layer.

8. The component of claim 1 wherein the cover layer comprises a polymer material and/or a molded material and/or an injection-molded material and/or a film and/or a polyurethane material and/or an acrylic material comprising silicone and/or a polymer material comprising fluorine and/or a stain-resistant polymer material.

9. The component of claim 1 wherein the structural substrate comprises a panel and/or a base and/or a fiber panel and/or a compressed fiber panel and/or a reduced-density material and/or a stiffness-retaining material and/or a molded substrate.

10. The component of claim 2 wherein the intermediate layer comprises a resilient material and/or a compressible material and/or a cushioning material and/or a foam material and/or a foam-based material and/or a film.

11. The component of claim 1 wherein the cover is configured to provide a surface effect comprising a visual effect and/or a performance effect

12. The component of claim 11 wherein the performance effect comprises stain resistance and/or fluid repellence and/or hardness and/or scratch resistance and/or tactile performance.

13. The component of claim 1 wherein the structural substrate comprises hemp fiberboard and/or foamed hemp fiberboard and/or foamed glass fiberboard and/or polypropylene and/or polyimide and/or polycarbonate.

14. The component of claim 1 wherein the base layer comprises a polyethylene terephthalate fiber material and/or a nonwoven fabric material and/or a mesh fabric and/or foam material and/or sponge material and/or thermoplastic polyester elastomer and/or a foamed material and/or polyethylene terephthalate fiber nonwoven fabric.

15. The component of claim 1 wherein the cover layer comprises thermoplastic polyester elastomer and/or thermoplastic vulcanized rubber and/or polyurethane and/or a self-skinned material formed from thermoplastic polyester elastomer.

16. The component of claim 1 wherein the barrier layer comprises polypropylene and/or polyethylene and/or polyethylene terephthalate and/or thermoplastic polyurethane elastomer and/or thermoplastic polyester elastomer wherein the barrier layer comprises a material configured to limit penetration of material of the cover layer into material of the base layer during formation of the cover; wherein the barrier layer comprises a material having compatibility with material of the cover layer; and wherein the barrier layer comprises a laminate with the base layer.

17. The component of claim 1 wherein the interface layer comprises polypropylene and/or polyethylene and/or polyethylene terephthalate and/or thermoplastic polyurethane elastomer and/or thermoplastic polyester elastomer; wherein the interface layer comprises a laminate with the structural substrate

18. The component of claim 1 wherein the cover layer material comprises antifouling coating characteristics; wherein the surface effect comprises adhesion evaluation and/or wear resistance and/or stain resistance evaluation and/or water droplet angle and/or feel evaluation and/or static and/or dynamic friction coefficient.

19. The component of claim 1 produced by a method comprising the steps of:
providing the base layer material for the cover;
providing the cover layer material for the cover on the base layer of the cover; and
providing the cover on the structural substrate;
wherein the step of providing the cover layer material for the cover on the base layer of the cover comprises forming the cover layer material on the base layer; and
wherein the step of providing the base layer material for the cover comprises forming the base layer from the base layer material on the structural substrate.

20. The method of claim 19 further comprising the step of forming a barrier layer between the base layer and the cover layer to form a layer structure.
